(19) United States
(12) Patent Application Publication
(10) Pub. No.: US 2026/0114354 A1
(43) Pub. Date: Apr. 30, 2026

(54) RIPPER POINT WEAR INDICATOR

(71) Applicant: DEERE & COMPANY, MOLINE, IL (US)

(72) Inventors: LUC JANELLE, ANKENY, IA (US); DAVID STEINLAGE, CENTRALIA, KS (US)

(21) Appl. No.: 19/337,438

(22) Filed: Sep. 23, 2025

Related U.S. Application Data
(60) Provisional application No. 63/714,284, filed on Oct. 31, 2024.
(60) Provisional application No. 63/884,706, filed on Sep. 19, 2025.

(51) Int. Cl. A01B 76/00; A01B 15/02; G01D 7/00

(52) U.S. Cl. CPC A01B 76/00; A01B 15/025; G01D 7/00

(57) ABSTRACT

In an embodiment, a tillage ripper point includes a body having a nose, an upper surface, lateral sides, and a rear surface. The tillage ripper point also includes a wear indicator configured to wear in a controlled fashion and thereby indicate to a user that the tillage ripper point has reached the end of its usable lifespan.

### INCORPORATION BY REFERENCE TO ANY PRIORITY APPLICATIONS

This application claims priority benefit of U.S. Provisional Application Nos. 63/714,284 (Dkt. No. P36604-US-PRO), filed on Oct. 31, 2024, and 63/884706 (Dkt. No. P38496-US-PRO), filed on Sep. 19, 2025. All of the above applications are incorporated by reference herein and are to be considered a part of this specification. Any and all applications for which foreign or domestic priority claim is identified in the Application Data Sheet as filed with the present application are hereby incorporated.

### BACKGROUND

### Field

The disclosure relates generally to a tillage ripper point, and more specifically, to a tillage ripper point configured to provide a low draft, enable high-speed operation and produce a smooth soil surface.

### Description of the Related Art

A wide range of agricultural implements have been developed and are presently in use for tilling and cultivating. Tillage implements, for example, are commonly towed behind tractors and may cover wide swaths of ground which may include various types of residue. Such residue may include materials left in the field after the crop has been harvested. These residues typically include stalks and stubble, leaves and seed pods. Good management of field residues can increase efficiency of irrigation and control of erosion in the field.

Accordingly, tillers may include ground engaging tools, such as shanks and tillage points, configured to condition the soil for improved moisture distribution while reducing soil compaction from such sources as machine traffic, grazing cattle, and standing water. The points are typically replaceable, and various points may be mounted on the shanks, depending upon the field conditions and the desired results of the tilling operation. A low draft tillage point that establishes a level soil surface having few clods may be desirable.

### SUMMARY

In some embodiments, a tillage ripper point comprises: a body, a first wing extending from the first lateral side of the body and a second wing extending from the second lateral side of the body, and at least one ripper point wear detector extending a distance from a surface of the ripper point. The body of the tillage ripper point may have a first upper surface having first and second first upper surface lateral edges, a second upper surface having first and second second upper surface later edges, a third upper surface having first and second third upper surface lateral edges, first and second lateral sides, and a nose at least partially defining a leading edge of the first upper surface. Each of the first wing and the second wing may have a top surface extending from the body of the ripper point, a bottom surface extending from the body of the ripper point, and a wing thickness. The ripper point wear detector may be configured to be substantially worn away at approximately the same time that the tillage ripper point reaches an end of a lifespan of the tillage ripper point.

In some embodiments, the at least one ripper point wear detector comprises at least one of a first ripper point wear detector comprising a first material having a first material hardness and extending a first distance from the first upper surface located between the first and second first upper surface lateral edges, a second ripper point wear detector comprising a second material having a second material hardness and extending a second distance from the second upper surface located between the first and second second upper surface lateral edges, and a third ripper point wear detector comprising a third material having a third material hardness and extending a third distance from the third upper surface located between the first and second third upper surface lateral edges. In some embodiments, at least one of the third material of the third ripper point wear detector and the second material of the second ripper point wear detector is different from the first material of the first ripper point wear detector. In some embodiments, at least one of the third material hardness of the third ripper point wear detector and the second material hardness of the second ripper point wear detector is different from the first material hardness of the first ripper point wear detector. In some embodiments, at least one of the third material hardness of the third ripper point wear detector and the second material hardness of the second ripper point wear detector is greater than the first material hardness of the first ripper point wear detector. In some embodiments, at least one of the third distance of the third ripper point wear detector and the second distance of the second ripper point wear detector is different from the first distance of the first ripper point wear detector. In some embodiments, at least one of the third distance of the third ripper point wear detector and the second distance of the second ripper point wear detector is greater than the first distance of the first ripper point wear detector. In some embodiments, the at least one ripper point wear detector comprises at least two of the first ripper point wear detector, and second ripper point wear detector, and the third ripper point wear detector.

In some embodiments, a tillage ripper point comprises: a body comprising at least one upper surface having first and second lateral edges, first and second lateral sides, and a nose; a first wing extending from the first lateral side of the body and a second wing extending from the second lateral side of the body, wherein each of the first wing and the second wing comprises a top surface extending from the body of the ripper point, a bottom surface extending from the body of the ripper point, and a wing thickness; and a ripper point wear detector extending from a first upper surface of the at least one upper surface, wherein the ripper point wear detector is configured to be worn away during use of the tillage ripper point and by reaching a worn state indicate that the tillage ripper point has reached an end of a lifespan of the tillage ripper point.

In some embodiments, the ripper point wear detector extends from the first upper surface of the at least one upper surface at a location at least partially intersecting a midline of the first upper surface between the first and second lateral edges of the first upper surface. In some embodiments, the ripper point wear detector comprises a mass and the worn state of the ripper point wear detector corresponds to a mass reduction of the ripper point wear detector of greater than 90%. In some embodiments, the worn state of the ripper point wear detector corresponds to a mass reduction of the ripper point wear detector of greater than 96%. In some embodiments, the ripper point wear detector extends from the first upper surface by a dimension and the worn state of the ripper point wear detector corresponds to a reduction of the dimension of the ripper point wear detector of greater than 90%. In some embodiments, the worn state of the ripper point wear detector corresponds to a reduction of the dimension of the ripper point wear detector of greater than 96%. In some embodiments, the ripper point wear detector comprises a ripper point wear detector material that is different than a material of the body of the tillage ripper point. In some embodiments, the ripper point wear detector material is softer than the material of the body of the tillage ripper point.

In some embodiments, a wear detector for a soil engaging component of an agricultural implement comprises: a wear detector body having a mass and extending a distance from a soil engaging surface of the soil engaging component of the agricultural implement, wherein the wear detector is configured to be worn away during use of the soil engaging component of the agricultural implement and by reaching a worn state indicate that the soil engaging component of the agricultural implement has reached an end of a lifespan of the soil engaging component of the agricultural implement.

In some embodiments, the worn state of the wear detector corresponds to a reduction in the mass of the wear detector by at least 90%. In some embodiments, the worn state of the wear detector corresponds to a reduction in the distance the wear detector extends from the soil engaging surface of the soil engaging component by at least 90%. In some embodiments, a material of the wear detector body is different from a material of the soil engaging component.

In some embodiments, a tillage ripper point comprises: a body having an upper surface, a first lateral side surface, a second lateral side surface, a lower surface, a rear surface, and a nose, and a first wing extending from the first lateral side surface and a second wing extending from the second lateral side surface. The upper surface may comprise a first planar surface, a second planar surface, and a third planar surface, the first planar surface connected to the second planar surface by a joint having a first angle, the second planar surface connected to the third planar surface by a joint having a second angle, wherein the third planar surface of the upper surface may be oriented at a third angle with respect to the surface of the soil. The first lateral side surface may include a first lateral side front section, a first lateral side middle section, and a first lateral side rear section, the first rear section of the first lateral side surface having a first transverse aperture configured to accept a fastener. The second lateral side surface may include a second lateral side front section, a second lateral side middle section, and a second lateral side rear section, the second lateral side rear section of the second lateral side surface having a second transverse aperture configured to accept the fastener. The lower surface may include a lower surface front section, a lower surface middle section and a lower surface rear section. The rear surface may have a rear surface upper section, a rear surface middle section, and a rear surface lower section, wherein the rear surface upper section connects to the third planar surface of the upper surface and the rear surface lower section connects to the lower surface rear section. The nose may comprise at least a portion of the first planar surface on its upper side and a substantially planar lower nose surface on its lower side. Each of the first wing and second wing may include: a wing root proximate the body of the ripper point, a top surface including an inner wing top surface and an outer wing top surface, a bottom surface including an inner wing bottom surface and an outer wing bottom surface, a lateral outer surface forming the lateral edge of the wing, a rear surface, and at least one forward surface. At least one of the inner wing top surface and the outer wing top surface may be continuously curviplanar. At least one of the inner wing bottom surface and the outer wing bottom surface may be continuously curviplanar. The top surface of the wing may include a top surface leading edge extending from the wing root to the lateral outer surface and a top surface trailing edge extending from the wing root to the lateral outer surface. At least a portion of the top surface leading edge may be continuously curvilinear and at least a portion of the top surface trailing edge may be continuously curvilinear. The bottom surface of the wing may include a bottom surface leading edge extending from the wing root to the lateral outer surface and a bottom surface trailing edge extending from the wing root to the lateral outer surface. At least a portion of the bottom surface leading edge may be continuously curvilinear and at least a portion of the bottom surface trailing edge may be continuously curvilinear.

In some embodiments, at least one of the top surface leading edge and the bottom surface leading edge is continuously curvilinear. In some embodiments, at least one of the top surface trailing edge and the bottom surface leading edge comprises a portion that is substantially linear. In some embodiments, the lateral outer surface of the first wing is substantially planar and parallel to at least one of the first lateral side front section, the first lateral side middle section, and the first lateral side rear section, and wherein the lateral outer surface of the second wing is substantially planar and parallel to at least one of the second lateral side front section, the second lateral side middle section, and the second lateral side rear section. In some embodiments, the first planar surface of the upper surface has a first lateral side and a second lateral side, the second planar surface of the upper surface has as first lateral side and a second lateral side, and the third planar surface of the upper surface has a first lateral side and a second lateral side. In some embodiments, the top surface leading edge of the first wing and the top surface trailing edge of the first wing intersect with the first lateral side of the third planar surface and the top surface leading edge of the second wing and the top surface trailing edge of the second wing intersect with the second lateral side of the third planar surface. In some embodiments, the at least one forward surface includes an upper leading surface and a lower leading surface, wherein the upper leading surface connects to the top surface at the top surface leading edge, wherein the upper leading surface connects to the lower leading surface, and wherein the lower leading surface connects to the bottom surface at the bottom surface leading edge. In some embodiments, the rear surface of the first wing and the rear surface of the second wing are part of the rear surface of the body, wherein the rear surface of the body is a continuous surface comprising both substantially curviplanar and substantially planar portions. In some embodiments, each of the first wing and the second wing further comprises a wing thickness, wherein the wing thickness decreases across at least a portion from the wing root to the lateral outer surface. In some embodiments, each of the first wing and the second wing further comprises a wing thickness, wherein the wing thickness decreases continuously from the wing root to the lateral outer surface.

In some embodiments, a tillage ripper point comprises: a body comprising at least one upper surface having first and second lateral edges, first and second lateral sides, and a nose; and a first wing extending from the first lateral side of the body and a second wing extending from the second lateral side of the body. Each of the first wing and the second wing may comprise: a top surface extending from the body of the ripper point at a wing root and having a lateral edge, a leading edge and a trailing edge; a bottom surface extending from the body of the ripper point at the wing root and having a leading edge and a trailing edge; at least one forward surface having an upper edge and a lower edge; and a wing thickness, the wing thickness decreasing across at least a portion of the wing from the wing root to the lateral edge of the top surface. The leading edge of the top surface may be at least partially curvilinear and backswept. At least one of the at least one forward surface may be continuously curviplanar and backswept.

In some embodiments, a thickness of the wing at the lateral edge of the top surface is less than a thickness of the wing at each point inside the lateral edge of the top surface. In some embodiments, the leading edge of the top surface is continuously curvilinear. In some embodiments, the lateral edge of the top surface is substantially parallel to a plane containing an uppermost surface of the at least one upper surface of the body.

In some embodiments, a tillage ripper point comprises: a body having a nose, an upper surface, first and second lateral sides, and a rear surface; and a first wing extending from the first lateral side of the body and a second wing extending from the second lateral side of the body. Each of the first wing and the second wing may comprise: a top surface having a leading edge with a first end on the body and forward of a second end at a lateral edge of the wing, wherein the leading edge is at least partially curvilinear.

In some embodiments, the leading edge is continuously curvilinear. In some embodiments, each of the first wing and the second wing further comprises: a wing thickness, wherein the wing thickness decreases from a wing root to the lateral edge of the wing. In some embodiments, the wing thickness decreases continuously from the wing root to the lateral edge of the wing. In some embodiments, a minimum wing thickness at one or more of an outer portion of the wing and the lateral edge of the wing is less than a thickness of the wing at each point inside the outer portion of the wing. In some embodiments, a trailing edge of the top surface is at least partially curvilinear.

### BRIEF DESCRIPTION OF THE DRAWINGS

FIG. 1 is a side view of a tillage implement, including ripper points.

FIG. 2 is a perspective view of an embodiment of a ripper point, including a nose having a steeper angle than the body and wings having a curvilinear front edge configured to fracture the soil.

FIGS. 3A and 3B are top and bottom views, respectively, of the ripper point of FIG. 6.

FIGS. 4A and 4B are front and rear views, respectively, of the ripper point of FIG. 2.

FIGS. 5A, 5B, and 5C are rear perspective views of the ripper point of FIG. 2.

FIGS. 6A and 6B are left and right side views, respectively, of the ripper point of FIG. 2.

### DETAILED DESCRIPTION

The present disclosure describes various tillage or ripper points configured to enable high-speed operation of a tillage implement, while producing a smooth soil surface. Generally, the ripper point include a body having a top surface and a nose extending from the top surface. The ripper point also includes two wings each disposed on a respective lateral side of the body and extending at least partially laterally outward. In some embodiments, the slope of the nose relative to a horizontal plane of movement of the tillage point through soil may be greater than the slope of the top surface of the body. In some embodiments, the nose is substantially flat in a lateral direction. In other embodiments, the nose is curvilinear and continuous with the top surface of the body. One or more of these features may serve to reduce drag by creating a turbulent flow of soil around the tillage point and directing soil away from the wings.

The wings may be configured to engage the soil at a shallower depth, i.e., distance under the surface of the soil, than the nose. In such a configuration, the nose may engage and fracture harder compacted soil, while the wings lift and/or twist the looser soil, thereby burying residue and adding oxygen to the soil. In some embodiments, a tip of each wing is configured to engage the soil at a greater depth than a respective wing root. In other embodiments, a tip of each wing is configured to engage the soil at a depth approximately equal to at least a portion of the respective wing root. Some configurations of the ripper points disclosed herein may substantially reduce or eliminate soil compaction under the wings. In some embodiments, the angle of the leading edge of each wing with respect to the body may be less than the angle of the wing's trailing edge with respect to the body. Some configurations of the ripper points disclosed herein may reduce soil turbulence above the wing, thereby providing a smoother soil surface. In some embodiments, each wing may be angled downwardly with respect to the body about an axis perpendicular to the direction of travel. Some embodiments of the ripper points disclosed herein may enable each wing to provide a greater degree of soil fracture, thereby increasing soil oxygen content and enhancing root growth.

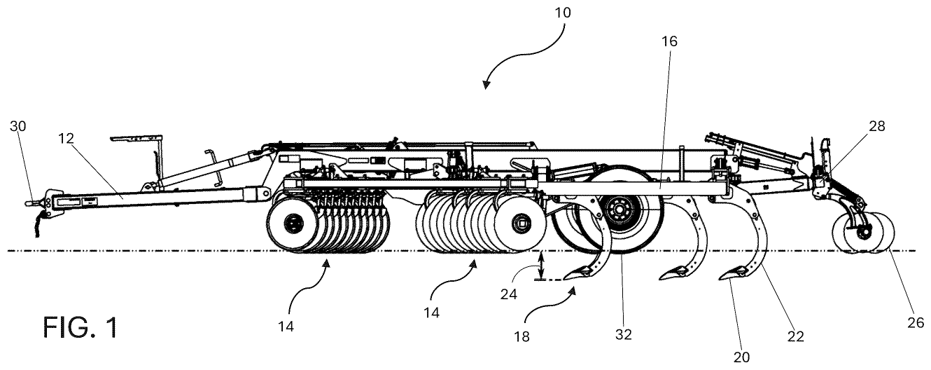

FIG. 1 illustrates an embodiment of a tillage implement 10. The tillage implement 10 may be used to till a field to prepare the soil by plowing, ripping, and/or turning. Soil residue, such as plant stalks and/or weeds, may be removed during the tilling process. Further, the soil may be loosened and aerated, which facilitates deeper penetration of roots. The tilling process may help in the growth of microorganisms present in the soil and thus, maintain or improve fertility of the soil. As shown, the tillage implement 10 includes a tow bar 12 having a coupling mechanism, such as a hitch, used to couple the implement 10 to a towing vehicle, such as a tractor. The tillage implement 10 generally includes a frame supported or carried by one or more wheels 32, the frame carrying ground engaging tools. The tillage implement 10 may include disk blades 14 coupled to a frame 16, which supports the blades 14, wheels, and other components of the tillage implement 10.

Multiple ground engaging tools may also be coupled to the frame 16, such as rippers 18. In certain embodiments, the ground engaging tools may include plows, chisels, hoe openers, harrow tines, tillage points, rippers or any combination thereof, or indeed any desired ground engaging tool. As shown, the rippers 18 include tillage or ripper points 20 coupled to the frame 16 by shanks 22. The ripper points 20 may be configured to enable high-speed operation of the tillage implement 10, while producing a smooth soil surface. As illustrated, the rippers 18 are positioned to till the field to a depth 24. The depth 24 of the tipper points 20 within the soil may be adjusted by raising or lowering frame 16, which may, in turn, raise or lower the ground engaging tools including the rippers 18. The depth 24 may be adjusted based on local farming practices and/or field conditions. The depth 24 and arrangement of the ground engaging tools, e.g., rippers 18, may create valleys and berms in the soil, which may be smoothed out and leveled off by soil shaping disks 26 or rolling baskets (not illustrated). A row of soil leveling disks 26 or rolling baskets may be disposed behind the ground engaging tools, e.g., rippers 18. The soil shaping disks 26 are coupled to a tool bar 28 that extends rearward from the frame 16. The row of soil shaping disks 26 may include a plurality of disk assemblies disposed at different locations along the tool bar 28. The arrangement and spacing of the individual disk assemblies along the tool bar 28 can improve the shape of the soil surface to improve germination while reducing soil compaction.

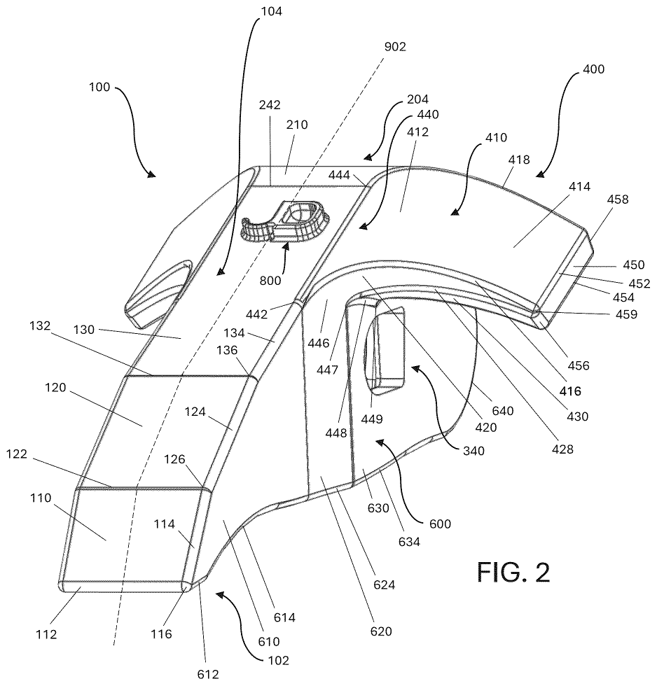

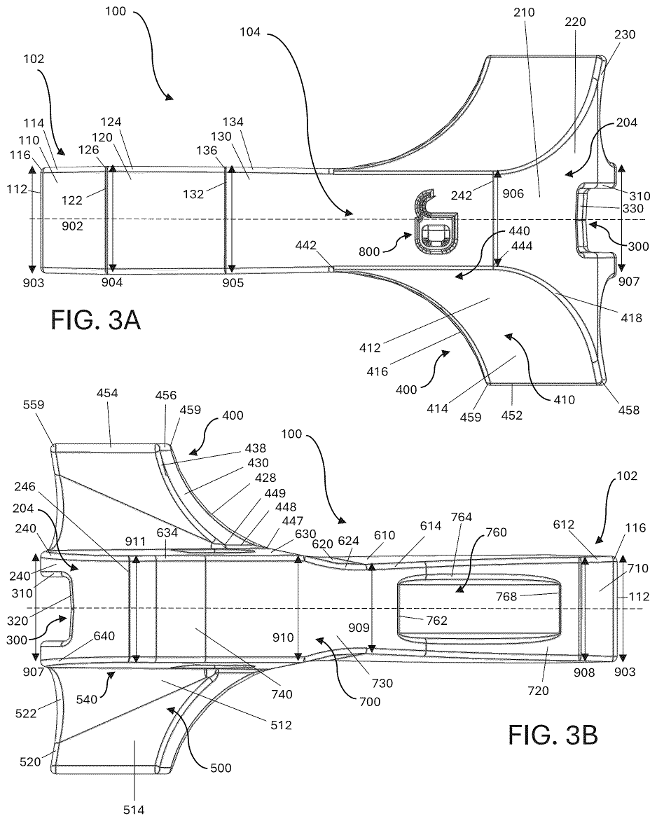

FIG. 2 illustrates a front three-quarters perspective view of an embodiment of a curve-winged ripper point 100, similar to the ripper point 20 shown in FIG. 1. The curve-winged ripper point 100 generally includes a body with a laterally extending first wing 400 and second wing 400. As shown in FIGS. 2, 3A-B, 4A-B, the curve-winged ripper point 100 is substantially bilaterally symmetrical about a line of bilateral symmetry 902. For this reason, the curve-winged ripper point 100 may be discussed in halves and element numbers for one half may be used for both halves. For example, as shown in FIG. 2, the right wing 400 is labeled with numerous element numbers while the left wing 400 has none. But, all element numbers and all description used herein to describe the right wing 400 applies equally to the left wing 400.

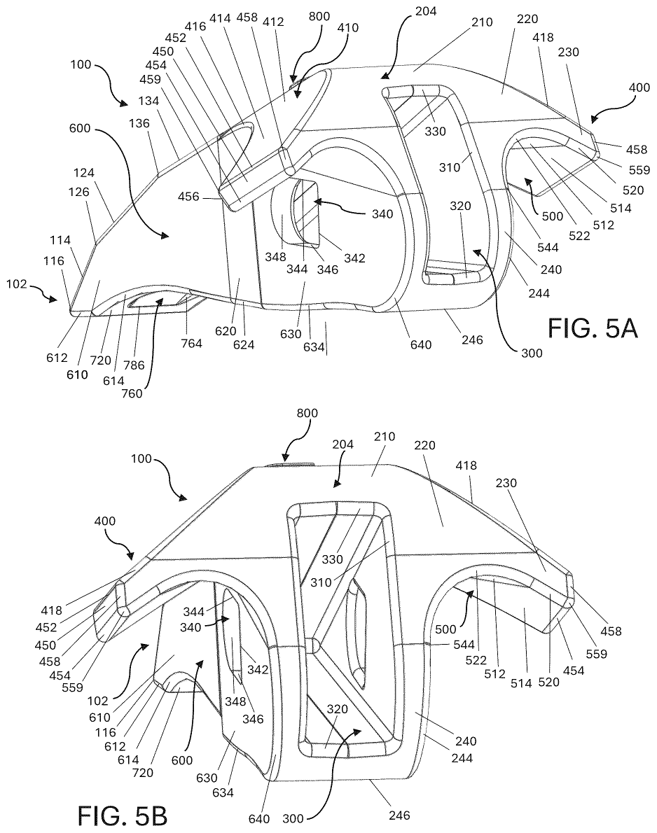

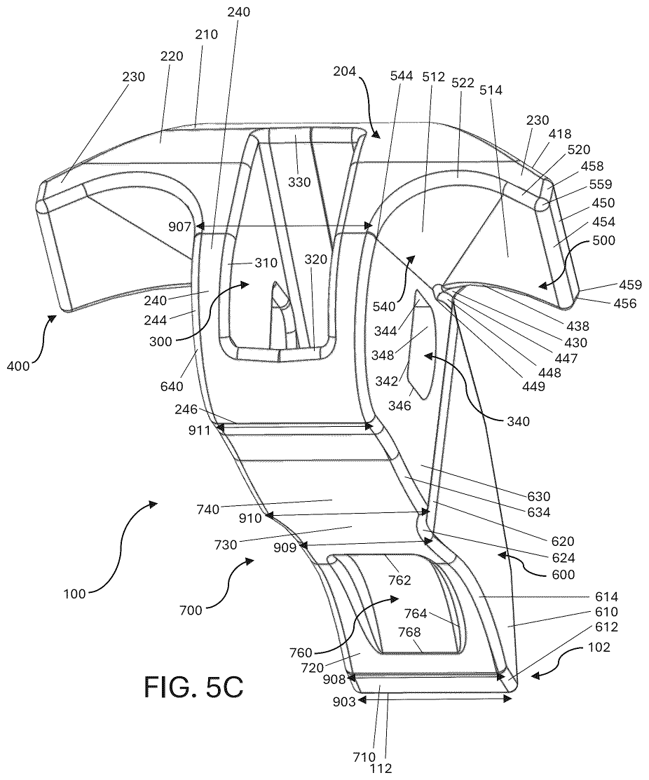

The body of the curve-winged ripper point 100 includes a nose 102 at its forward, anterior, or leading end and a heel 640 at its rear, posterior, or trailing end. With reference to FIGS. 5A-5C, the curve-winged ripper point 100 includes a shank socket 300 configured to accept a shank 22. The shank socket 300 may be configured to mate with the shank 22, such that the shank socket 300 forms a female portion of a mating engagement and the shank 22 forms a male portion of the mating engagement. The shank socket 300 may include any of a number of female configurations. In some embodiments, the shank socket 300 is defined, at least partially by a shank socket upper edge 330, a shank socket lower edge 320, and two shank socket lateral edges 310.

With reference to FIGS. 5A-5C, the side walls of the body of the curve-winged ripper point 100 may include transverse apertures 340. For example, the curve-winged ripper point 100 may include a transverse aperture 340 in the left rear side surface 630 and the right rear side surface 630. The transverse aperture 340 may intersect the shank socket 300. In this way a fastener may be passed through one or more of the transverse apertures 340 and through an aperture in the shank 22 (not shown) which is held within the shank socket 300. Thus, the fastener may hold, fix, or lock the curve-winged ripper point 100 to the shank 22.

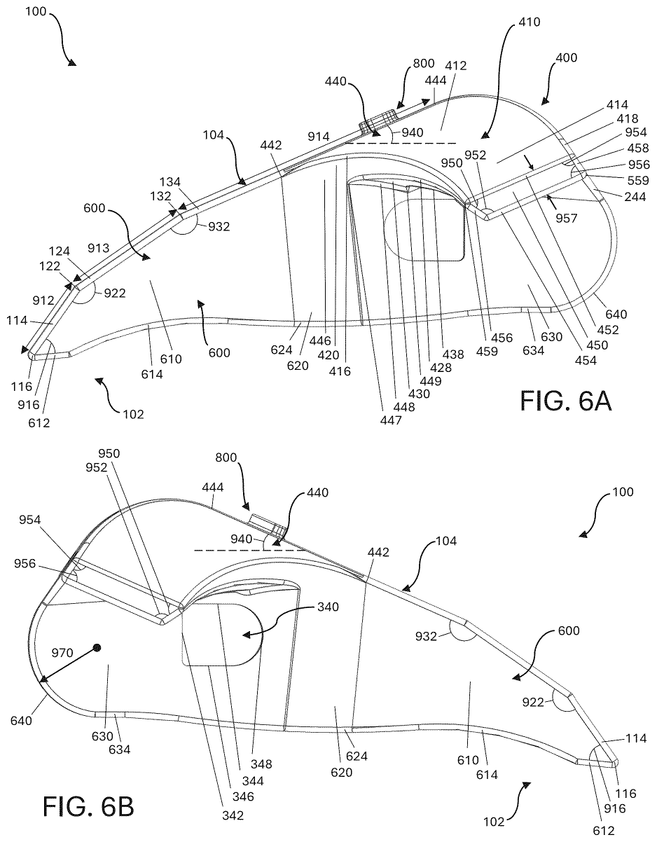

In some embodiments, the transverse aperture 340 is a keyed aperture configured to accept a fastener in a set orientation. The transverse apertures 340 shown in FIG. 5A-5C are keyed apertures, configured to accept a D-shaped fastener in a set orientation. Each transverse aperture 340 includes an aperture rear face 342, a curved aperture forward face 348, an aperture upper face 344, and an aperture lower face 346. As shown best in FIG. 6B, the transverse aperture 340 may have a roughly D-shape, including a substantially flat aperture rear face 342 at its rear end, a substantially flat aperture upper face 344 on its upper side and joined to the aperture rear face 342 at its rear end, a substantially flat aperture lower face 346 on its lower side and joined to the aperture rear face 342 at its rear end, and a curved, e.g., continuously curved, aperture forward face 348 connected to the forward ends of the aperture upper face 344 and the aperture lower face 346. In some embodiments, the joints between the aperture upper face 344 and the aperture lower face 346 and the aperture rear face 342 are radiused. In other embodiments, the joints between the aperture upper face 344 and the aperture lower face 346 and the aperture rear face 342 are substantially right angles. Other keyed transverse apertures 340 (and fasteners) are envisioned by this disclosure. For example, the transverse aperture 340 may be square shaped, oval shaped, diamond shaped, or any other shape that provides an advantageous keyed configuration with a keyed fastener. In some embodiments, the transverse aperture 340 is an eccentric shape, for example a lobed shape. Engagement between a keyed fastener, a keyed transverse aperture 340, and a keyed aperture in the shank 22 may advantageously inhibit or minimize rotation of the curve-winged ripper point 100 with respect to the shank 22 during use, e.g., in addition to any mating engagement between the curve-winged ripper point 100 and the shank 22 or to overcome any play or lack of mating engagement between the curve-winged ripper point 100 and the shank 22.

In some embodiments, the transverse aperture 340 is not keyed and can accept a fastener in any rotational position. In such embodiments, the transverse aperture 340 may be a generally circular or conical aperture configure to accept a generally cylindrical or conical pin/fastener. Any other non-keyed transverse aperture 340 may be employed. A non-keyed aperture may advantageously allow simple or easier insertion of a fastener with less visual or tactile input from an operator, as the fastener may be inserted into the non-keyed transverse aperture 340 in any rotational orientation. Such non-keyed embodiments of the transverse aperture 340 may provide for easier and faster replacement of a curve-winged ripper point 100, e.g., a damaged curve-winged ripper point 100.

The cross-sectional dimensions of the transverse aperture 340, e.g., the distance between the aperture lower face 346 and aperture upper face 344 and the distance between the aperture forward face 348 and the aperture rear face 342, are sufficiently large so as to avoid shearing of the fastener when the curve-winged ripper point 100 is in use. In other words, the fastener (and thus the transverse apertures 340 which matingly accept the fastener) should be sufficiently large that the fastener does not shear during use, when the curve-winged ripper point 100 rapidly changed draft forces, e.g., when the curve-winged ripper point 100 hits a rock in the soil of the field.

In some embodiments, the transverse apertures 340 on the left and right side of the curve-winged ripper point 100, and thus, potentially, the fastener, are substantially the same size or equal in size. In some embodiments, the front to rear distance of the transverse aperture 340, i.e., the distance from the forwardmost point of the aperture forward face 348 to the aperture rear face 342, is between about 0.25-1.25 inches, 0.3-1.2 inches, 0.35-1.15 inches, 0.4-1.1 inches, 0.45-1.05 inches, 0.5-1.0 inches, 0.55-0.95 inches, 0.6-0.9 inches, 0.65-0.85 inches, or 0.7-0.8 inches, or any other distance that advantageously matingly accepts a fastener configured to resist shear during use. In some embodiments, the front to rear distance of the transverse aperture 340 is less than about 2 inches, 1.9 inches, 1.8 inches, 1.7 inches, 1.6 inches, 1.5 inches, 1.4 inches, 1.3 inches, 1.2 inches, 1.1 inches, 1.0 inches, 0.9 inches, 0.8 inches, 0.7 inches, 0.6 inches, 0.5 inches, 0.4 inches, 0.3 inches, or 0.2 inches, or any other distance that advantageously matingly accepts a fastener configured to resist shear during use. In some embodiments, the top to bottom distance of the transverse aperture 340, i.e., the distance from the aperture upper face 344 to the aperture lower face 346 is between about 0.25-1.25 inches, 0.3-1.2 inches, 0.35-1.15 inches, 0.4-1.1 inches, 0.45-1.05 inches, 0.5-1.0 inches, 0.55-0.95 inches, 0.6-0.9 inches, 0.65-0.85 inches, or 0.7-0.8 inches, or any other distance that advantageously matingly accepts a fastener configured to resist shear during use. In some embodiments, the top to bottom distance of the transverse aperture 340 is less than about 2 inches, 1.9 inches, 1.8 inches, 1.7 inches, 1.6 inches, 1.5 inches, 1.4 inches, 1.3 inches, 1.2 inches, 1.1 inches, 1.0 inches, 0.9 inches, 0.8 inches, 0.7 inches, 0.6 inches, 0.5 inches, 0.4 inches, 0.3 inches, or 0.2 inches, or any other distance that advantageously matingly accepts a fastener configured to resist shear during use.

In some embodiments, the mating engagement between the shank 22 and the shank socket 300 of the curve-winged ripper point 100 defines the angle of attack 940 of the curve-winged ripper point 100. The angle of attack 940 may be defined as the angle of the third upper surface face lateral edge 134 with respect to level, e.g., the surface of the soil of the field. The angle of attack 940, combined with the various other structural features of the curve-winged ripper point 100 (e.g., the second upper surface joint angle 932 and the first upper surface joint angle 922, among others) define how the various components of the curve-winged ripper point 100, including with particular emphasis, the nose 102 and the two wings 400 interact with the soil during use. In some embodiments, the angle of attack 940 is between about 0-70°, 5-65°, 10-60°, 15-55°, 20-50°, 25-45°, or 30-40°, or any other angle that advantageously facilitates a tilling function of the curve-winged ripper point 100. In some embodiments, the angle of attack 940 is less than about 75°, 70°, 65°, 60°, 55°, 50°, 45°, 40°, 35°, 30°, 25°, 20°, 15°, 10°, or 5°, or any other angle that advantageously facilitates a tilling function of the curve-winged ripper point 100. In some embodiments, the angle of attack 940 is greater than about 5°, 10°, 15°, 20°, 25°, 30°, 35°, 40°, 45°, 50°, 55°, 60°, 65°, or 70°, or any other angle that advantageously facilitates a tilling function of the curve-winged ripper point 100.

Turning to FIG. 2, the curve-winged ripper point 100 includes a both which terminates at the forward, leading, or anterior end, in a nose 102. As mentioned, the shank socket 300 and its mating engagement with the shank 22 define the angle of attack 940, which, in turn, defines the angle that the nose 102 and its various components interact with the soil. The nose 102 includes, generally speaking, a nose edge 112 with a nose edge lateral point 116 on its right lateral side and a nose edge lateral point 116 on its left lateral side. The nose 102 and the body of the curve-winged ripper point 100 have an upper surface 104 defined by a number of surfaces. The curve-winged ripper point 100 shown in FIG. 2 includes three flat upper surfaces and a generally curved or curviplanar surface. Each surface will be described herein, in detail. In some embodiments, the upper surface 104 of the curve-winged ripper point 100 includes 1, 2, 3, 4, 5, or 6 distinct surfaces.

In some embodiments, each distinct surface of the upper surface 104 is planar. In other embodiments, each distinct surface of the 104 is curviplanar. In some embodiments, each distinct surface of the upper surface 104 is substantially linear in planes parallel to the line of bilateral symmetry 902. In such embodiments, the distinct surface(s) may be curvilinear in planes perpendicular to the line of bilateral symmetry 902. In other embodiments, each distinct surface of the upper surface 104 is substantially linear in planes perpendicular to the line of bilateral symmetry 902. In such embodiments, the distinct surface(s) may be curvilinear in planes parallel to the line of bilateral symmetry 902.

The forwardmost portion of the nose 102 is formed by the lower nose surface 710 (see FIG. 3B) on the bottom and the first upper surface face 110 on the top. The first upper surface face 110 and the lower nose surface 710 meet at the nose edge 112. In some embodiments, including that shown in FIG. 2, the nose edge 112 is a radiused joint (e.g., a convex radiused joint). In other embodiments, the nose edge 112 is a sharp joint (e.g., with little to no radius). The nose edge 112 has a nose edge lateral point 116 on each lateral side. In some embodiments, the nose edge lateral point 116 on each lateral side of the nose edge 112 is a radiused point. In other embodiments, the nose edge lateral point 116 on each lateral side of the nose edge 112 is a sharp point, e.g., with a very small to non-existent radius.

The first upper surface face 110 includes a first upper surface face lateral edge 114 on each of its left and right sides. In some embodiments, each first upper surface face lateral edge 114 is a radiused or rounded edge. In some embodiments, each first upper surface face lateral edge 114 is a sharp or angled edge or joint. The first upper surface face 110 is bounded on its upper end by at least a portion of the first upper surface joint 122, where it meets the second upper surface face 120 (discussed elsewhere herein). Turning to FIG. 3A and FIG. 6A, the first upper surface face 110 is defined by a nose width 903 at its leading edge, a first joint width 904 at its trailing edge, and, as the first upper surface face 110 is substantially bilaterally symmetrical about the line of bilateral symmetry 902, a first upper surface face length 912. The nose width 903 is defined as the distance between the widest dimension of the nose edge 112, e.g., the widest dimension from one nose edge lateral point 116 to the other nose edge lateral point 116. In much the same way, the first joint width 904 is defined as the widest dimension of the first upper surface joint 122 from one first joint lateral point 126 to the other first joint lateral point 126. The first upper surface face length 912 is defined as the distance from the nose edge 112 to the first upper surface joint 122 along a line parallel to the line of bilateral symmetry 902. In some embodiments, the first upper surface face 110 is generally square. In some embodiments, the first upper surface face 110 is generally rectangular or generally a right trapezoid.

In some embodiments, the ratio between the first joint width 904 and the nose width 903 is about 100%. In other embodiments, the ratio between the first joint width 904 and the nose width 903 is less than 100%. For example, in such embodiments, the ratio between the first joint width 904 and the nose width 903 may be less than about 100%, 95%, 90%, 85%, 80%, 75%, 70%, 65%, 60%, 55%, or 50%, or any other ratio that advantageously interacts with the soil during use. In the same way, in some embodiments, the ratio between the first joint width 904 and the nose width 903 may be between about 50-100%, 55-95%, 60-90%, 65-85%, or 70-80%, or any other ratio that advantageously interacts with the soil during use. In still other embodiments, the ratio between the first joint width 904 and the nose width 903 is greater than 100%. For example, in such embodiments, the ratio between the first joint width 904 and the nose width 903 may be greater than 100%, 105%, 110%, 115%, 120%, 125%, 130%, 135%, 140%, 145%, or 150%, or any other ratio that advantageously interacts with the soil during use. In the same way, in some embodiments, the ratio between the first joint width 904 and the nose width 903 may be between about 100-150%, 105-145%, 110-140%, 115-135%, or 120-130%, or any other ratio that advantageously interacts with the soil during use.

In some embodiments, the ratio between the first upper surface face length 912 and the nose width 903 is less than 100%. In some embodiments, the ratio between the first upper surface face length 912 and the nose width 903 is between about 50-100%, 55-95%, 60-90%, 65-85%, or 70-80%, or any other ratio that advantageously interacts with the soil during use. In some embodiments, the ratio between the first upper surface face length 912 and the nose width 903 is less than about 100%, 95%, 80%, 85%, 80%, 75%, 70%, 65%, 60%, 55%, 50%, 45%, or 40%, or any other ratio that advantageously interacts with the soil during use. In some embodiments, the ratio between the first upper surface face length 912 and the nose width 903 is greater than 100%. In some embodiments, the ratio between the first upper surface face length 912 and the nose width 903 is between about 100-150%, 105-145%, 110-140%, 115-135%, or 120-130%, or any other ratio that advantageously interacts with the soil during use. In some embodiments, the ratio between the first upper surface face length 912 and the nose width 903 is greater than about 100%, 105%, 110%, 115%, 120%, 125%, 130%, 135%, 140%, 145%, 150%, 155%, or 160%, or any other ratio that advantageously interacts with the soil during use.

With continued reference to FIG. 3A and FIG. 6A, the second upper surface face 120 includes a second upper surface lateral edge 124 on each of its left and right sides. In some embodiments, each second upper surface lateral edge 124 is a radiused or rounded edge. In some embodiments, each second upper surface lateral edge 124 is a sharp or angled edge or joint. The second upper surface face 120 is bounded on its lower end by at least a portion of the first upper surface joint 122, where it meets the upper or trailing edge first upper surface face 110. The second upper surface face 120 is bounded on its upper or trailing end by at least a portion of the second upper surface joint 132, where it meets the leading edge of the third upper surface face 130 (discussed elsewhere herein). The second upper surface face 120 is defined by a first joint width 904 at its leading edge, a second joint width 905 at its trailing edge, and, as the second upper surface face 120 is substantially bilaterally symmetrical about the line of bilateral symmetry 902, a second upper surface face length 913. The first joint width 904 is defined as the distance between the widest dimension of the first upper surface joint 122, e.g., the widest dimension from one first joint lateral point 126 to the other first joint lateral point 126. In much the same way, the second joint width 905 is defined as the widest dimension of the second upper surface joint 132 from one second joint lateral point 136 to the other second joint lateral point 136. The second upper surface face length 913 is defined as the distance from the first upper surface joint 122 to the second upper surface joint 132 along a line parallel to the line of bilateral symmetry 902. In some embodiments, the second upper surface face 120 is generally square. In some embodiments, the 120 is generally a right trapezoid.

In some embodiments, the ratio between the between the second joint width 905 and the first joint width 904 is about 100%. In other embodiments, the ratio between the second joint width 905 and the first joint width 904 is less than 100%. For example, in such embodiments, the ratio between the second joint width 905 and the first joint width 904 may be less than about 100%, 95%, 90%, 85%, 80%, 75%, 70%, 65%, 60%, 55%, or 50%, or any other ratio that advantageously interacts with the soil during use. In the same way, in some embodiments, the ratio between the second joint width 905 and the first joint width 904 may be between about 50-100%, 55-95%, 60-90%, 65-85%, or 70-80%, or any other ratio that advantageously interacts with the soil during use. In still other embodiments, the ratio between the second joint width 905 and the first joint width 904 is greater than 100%. For example, in such embodiments, the ratio between the second joint width 905 and the first joint width 904 may be greater than 100%, 105%, 110%, 115%, 120%, 125%, 130%, 135%, 140%, 145%, or 150%, or any other ratio that advantageously interacts with the soil during use. In the same way, in some embodiments, the ratio between the second joint width 905 and the first joint width 904 may be between about 100-150%, 105-145%, 110-140%, 115-135%, or 120-130%, or any other ratio that advantageously interacts with the soil during use.

In some embodiments, the ratio between the second upper surface face length 913 and the first joint width 904 is less than 100%. In some embodiments, the ratio between the second upper surface face length 913 and the first joint width 904 is between about 50-100%, 55-95%, 60-90%, 65-85%, or 70-80%, or any other ratio that advantageously interacts with the soil during use. In some embodiments, the ratio between the second upper surface face length 913 and the first joint width 904 is less than about 100%, 95%, 80%, 85%, 80%, 75%, 70%, 65%, 60%, 55%, 50%, 45%, or 40%, or any other ratio that advantageously interacts with the soil during use. In some embodiments, the ratio between the second upper surface face length 913 and the first joint width 904 is greater than 100%. In some embodiments, the ratio between the second upper surface face length 913 and the first joint width 904 is between about 100-200%, 105-195%, 110-190%, 115-185%, 120-180%, 125-175%, 130-170%, 135-165%, 140-160%, or 145-155%, or any other ratio that advantageously interacts with the soil during use. In some embodiments, the ratio between the second upper surface face length 913 and the first joint width 904 is greater than about 100%, 105%, 110%, 115%, 120%, 125%, 130%, 135%, 140%, 145%, 150%, 155%, 160%, 165%, 170%, 175%, 180%, 185%, 190%, 195%, or 200%, or any other ratio that advantageously interacts with the soil during use.

Still referring to FIG. 3A and FIG. 6A, the third upper surface face 130 includes a third upper surface face lateral edge 134 on each of its left and right sides. In some embodiments, each third upper surface face lateral edge 134 is a radiused or rounded edge. In some embodiments, each third upper surface face lateral edge 134 is a sharp or angled edge or joint. The third upper surface face 130 is bounded on its lower end by at least a portion of the second upper surface joint 132, where it meets the upper or trailing edge second upper surface face 120. The third upper surface face 130 is bounded on its upper or trailing end by at least a portion of the third upper surface joint 242, where it meets the leading edge of the rear surface 204 (discussed elsewhere herein). The third upper surface face 130 is defined by a second joint width 905 at its leading edge, a third joint width 906 at its trailing edge, and, as the third upper surface face 130 is substantially bilaterally symmetrical about the line of bilateral symmetry 902, a second upper surface face length 914. The second joint width 905 is defined as the distance between the widest dimension of the second upper surface joint 132, e.g., the widest dimension from one second upper surface joint 132 to the other second upper surface joint 132. In much the same way, the third joint width 906 is defined as the widest dimension of the third upper surface joint 242 from one end of the third upper surface joint 242 (in some embodiments, the trailing wing root insertion point 444) to the other end of the third upper surface joint 242. The second upper surface face length 914 is defined as the distance from the second upper surface joint 132 to the third upper surface joint 242 along a line parallel to the line of bilateral symmetry 902. In some embodiments, the third upper surface face 130 is generally square. In some embodiments, the third upper surface face 130 is generally a right trapezoid.

In some embodiments, the ratio between the third joint width 906 and the second joint width 905 is about 100%. In other embodiments, the ratio between the third joint width 906 and the second joint width 905 is less than 100%. For example, in such embodiments the ratio between the third joint width 906 and the second joint width 905 may be less than about 100%, 95%, 90%, 85%, 80%, 75%, 70%, 65%, 60%, 55%, or 50%, or any other ratio that advantageously interacts with the soil during use. In the same way, in some embodiments, the ratio between the third joint width 906 and the second joint width 905 may be between about 50-100%, 55-95%, 60-90%, 65-85%, or 70-80%, or any other ratio that advantageously interacts with the soil during use. In still other embodiments, the ratio between the third joint width 906 and the second joint width 905 is greater than 100%. For example, in such embodiments, the ratio between the third joint width 906 and the second joint width 905 may be greater than 100%, 105%, 110%, 115%, 120%, 125%, 130%, 135%, 140%, 145%, or 150%, or any other ratio that advantageously interacts with the soil during use. In the same way, in some embodiments, the ratio between the third joint width 906 and the second joint width 905 may be between about 150%, 105-145%, 110-140%, 115-135%, or 120-130%, or any other ratio that advantageously interacts with the soil during use.

In some embodiments, the ratio between the third upper surface face length 914 and the second joint width 905 is less than 100%. In some embodiments, the ratio between the third upper surface face length 914 and the second joint width 905 is between about 50-100%, 55-95%, 60-90%, 65-85%, or 70-80%, or any other ratio that advantageously interacts with the soil during use. In some embodiments, the ratio between the third upper surface face length 914 and the second joint width 905 is less than about 100%, 95%, 80%, 85%, 80%, 75%, 70%, 65%, 60%, 55%, 50%, 45%, or 40%, or any other ratio that advantageously interacts with the soil during use. In some embodiments, the ratio between the third upper surface face length 914 and the second joint width 905 is greater than 100%. In some embodiments, the ratio between the third upper surface face length 914 and the second joint width 905 is between about 100-400%, 110-390%, 120-380%, 130-370%, 140-360%, 150-350%, 160-340%, 170-330%, 180-320%, 190-310%, 200-300%, 210-390%, 220-380%, 230-370%, 240-360%, 250-350%, 260-340%, 270-330%, 280-320%, or 290-310%, or any other ratio that advantageously interacts with the soil during use. In some embodiments, the ratio between the third upper surface face length 914 and the second joint width 905 is greater than about 150%, 160%, 170%, 180%, 190%, 200%, 210%, 220%, 230%, 240%, 250%, 260%, 270%, 280%, 290%, 300%, 310%, 320%, 330%, 340%, 350%, 360%, 370%, 380%, 3905, or 400%, or any other ratio that advantageously interacts with the soil during use.

Turning to FIG. 6A, the third upper surface face 130 is held at the angle of attack 940, as discussed elsewhere herein (i.e., held during use, with respect to the horizontal or the surface of the soil). The second upper surface face 120 is at an angle with respect to the third upper surface face 130. In other words, the second upper surface face 120 and the third upper surface face 130 meet at the second upper surface joint 132 and the second upper surface face 120 extends away from the third upper surface face 130 at that second upper surface joint 132. The second upper surface face 120 and the third upper surface face 130 meet at the second upper surface joint 132 such that a second upper surface joint angle 932 is formed.

As shown in FIG. 6A (and other figures depicting the curve-winged ripper point 100), the second upper surface joint angle 932 is less than 180°. In some embodiments, the second upper surface joint angle 932 is less than 180°. For example, in such embodiments, the second upper surface joint angle 932 may be less than about 180°, 178°, 176°, 174°, 172°, 170°, 168°, 166°, 164°, 162°, 160°, 158°, 156°, 154°, 152°, 150°, 148°, 146°, 144°, 142°, or 140°, or any other angle that advantageously interacts or positions the upper surface 104 of the curve-winged ripper point 100 to interact with the soil during use. In some embodiments, the second upper surface joint angle 932 is between about 160-180°, 162-178°, 164-176°, 166-174°, or 168-172°, or any other angle that advantageously interacts or positions the upper surface 104 of the curve-winged ripper point 100 to interact with the soil during use. In other embodiments, the second upper surface joint angle 932 is approximately equal (or equal) to 180°. In still yet other embodiments, the second upper surface joint angle 932 is greater than 180°. For example, in such embodiments, the second upper surface joint angle 932 may be greater than about 180°, 182°, 184°, 186°, 188°, 190°, 192°, 194°, 196°, 198°, or 200°, or any other angle that advantageously interacts or positions the upper surface 104 of the curve-winged ripper point 100 to interact with the soil during use. In some embodiments, the second upper surface joint angle 932 is between about 180-200°, 181-198°, 182-196°, 183-194°, 184-192°, 185-190°, or 186-188°, or any other angle that advantageously interacts or positions the upper surface 104 of the curve-winged ripper point 100 to interact with the soil during use.

The first upper surface face 110 is at an angle with respect to the third upper surface face 130. In other words, the first upper surface face 110 and the second upper surface face 120 meet at the first upper surface joint 122 and the first upper surface face 110 extends away from the second upper surface face 120 at that first upper surface joint 122. The first upper surface face 110 and the third upper surface face 130 meet at the first upper surface joint 122 such that a first upper surface joint angle 922 is formed.

With continued reference to FIG. 6A (and other figures depicting the curve-winged ripper point 100), the first upper surface joint angle 922 is less than 180°. As shown in FIG. 6A, the first upper surface joint angle 922 is less than the second upper surface joint angle 932. But, one of ordinary skill in the art will understand that: the first upper surface joint angle 922 may be less than the second upper surface joint angle 932; the first upper surface joint angle 922 may be equal or approximately equal to the second upper surface joint angle 932; and the first upper surface joint angle 922 may be greater than the second upper surface joint angle 932. In some embodiments, the first upper surface joint angle 922 is less than 180°. For example, in such embodiments, the first upper surface joint angle 922 may be less than about 180°, 178°, 176°, 174°, 172°, 170°, 168°, 166°, 164°, 162°, 160°, 158°, 156°, 154°, 152°, 150°, 148°, 146°, 144°, 142°, or 140°, or any other angle that advantageously interacts or positions the upper surface 104 of the curve-winged ripper point 100 to interact with the soil during use. In some embodiments, the first upper surface joint angle 922 is between about 160-180°, 162-178°, 164-176°, 166-174°, or 168-172°, or any other angle that advantageously interacts or positions the upper surface 104 of the curve-winged ripper point 100 to interact with the soil during use. In other embodiments, the first upper surface joint angle 922 is approximately equal (or equal) to 180°. In still yet other embodiments, the first upper surface joint angle 922 is greater than 180°. For example, in such embodiments, the first upper surface joint angle 922 may be greater than about 180°, 182°, 184°, 186°, 188°, 190°, 192°, 194°, 196°, 198°, or 200°, or any other angle that advantageously interacts or positions the upper surface 104 of the curve-winged ripper point 100 to interact with the soil during use. In some embodiments, the first upper surface joint angle 922 is between about 180-200°, 181-198°, 182-196°, 183-194°, 184-192°, 185-190°, or 186-188°, or any other angle that advantageously interacts or positions the upper surface 104 of the curve-winged ripper point 100 to interact with the soil during use.

With reference to FIG. 2 and FIG. 5C, it will be appreciated that the forward portion or tip of the nose 102 is defined or formed by the first upper surface face 110 as its upper surface and the lower nose surface 710 (see FIG. 5C) as its lower surface. As mentioned previously, the first upper surface face 110, at its lower or forwardmost end, meets the lower nose surface 710 at its forwardmost end at the nose edge 112. The lower nose surface 710 includes a lower nose surface lateral edge 612 on each of its left and right sides. In some embodiments, each lower nose surface lateral edge 612 is a radiused or rounded edge. In some embodiments, each lower nose surface lateral edge 612 is a sharp or angled edge or joint. The nose edge lateral point 116 on the left and right bound the nose edge 112. The first upper surface face 110 and the nose edge 112 form the profile of the forward portion of the nose 102. As shown in FIGS. 5A and 6A, the side of the nose 102 is formed by the forward side surface 610, which will be discussed in additional detail elsewhere herein.

With reference to FIG. 6A, the lower nose surface 710 meets the first upper surface face 110 at the nose edge 112 at a nose angle 916. The skilled artisan will understand that the smaller the nose angle 916 the shaper the nose 102 of the curve-winged ripper point 100 will be and the larger the nose angle 916 the blunter the nose 102 of the curve-winged ripper point 100 will be. As shown in FIG. 6A, the nose angle 916 is approximately 35°. In some embodiments, the nose angle 916 is less than about 90°. For example, in such embodiments, the nose angle 916 may be less than about 90°, 88°, 86°, 84°, 82°, 80°, 78°, 76°, 74°, 72°, 70°, 68°, 66°, 64°, 62°, 60°, 58°, 56°, 54°, 52°, 50°, 48°, 46°, 44°, 42°, 40°, 38°, 36°, 34°, 32°, 30°, 28°, 26°, 24°, 22°, 20°, 18°, or 16°, or any other angle that advantageously allows the nose 102 of the curve-winged ripper point 100 to interact with the soil during use. In some embodiments, the nose angle 916 is between about 20-60°, 21-58°, 22-56°, 23-54°, 24-52°, 25-50°, 26-48°, 27-46°, 28-44°, 29-42°, 30-40°, 31-38°, 32-36°, or 33-34°, or any other angle that advantageously allows the nose 102 of the curve-winged ripper point 100 to interact with the soil during use.

The body of the curve-winged ripper point 100 has a number of sidewalls. While the sidewalls are discussed herein separately, as separate items, the sidewalls may be separate and distinct, i.e., discontinuous, or the sidewalls may transition directly into each other, i.e., continuous. With reference to FIG. 6B, the curve-winged ripper point 100 is shown as having a forward side surface 610, a middle side surface 620 and a rear side surface 630. In some embodiments, including that shown, the side surface 600 of the curve-winged ripper point 100 includes three sections. In other embodiments, the side surface 600 of the curve-winged ripper point 100 includes fewer than three sections, e.g., 1 section or 2 sections. In yet other embodiments, the side surface 600 of the curve-winged ripper point 100 includes more than three surfaces. For example, in such embodiments, the side surface 600 of the curve-winged ripper point 100 may include 4, 5, 6, 7, or 8 sections, or any other number of sections that advantageously configure the curve-winged ripper point 100 to engage with the soil.

It should be understood that the transition between the forward side surface 610 and the middle side surface 620 may be distinct (e.g., identifiable as a particular location, such as one planar or curviplanar surface meeting another planar or curviplanar surface) or it may be indistinct (e.g., not particularly identifiable, such as a single curviplanar surface, which may change, or gently change in curvature). In the same way, the transition between the middle side surface 620 and the rear side surface 630 may be distinct (e.g., identifiable as a particular location, such as one planar or curviplanar surface meeting another planar or curviplanar surface) or it may be indistinct (e.g., not particularly identifiable, such as a single curviplanar surface, which may change, or gently change in curvature).

The forward side surface 610 may be bounded on its upper or top side by at least a portion of the first upper surface face lateral edge 114. The forward side surface 610 may be bounded on its upper or top side by at least a portion of the second upper surface lateral edge 124. The forward side surface 610 may be bounded on its upper or top side by at least a portion of the third upper surface face lateral edge 134. In some embodiments, the forward side surface 610 is bounded on its upper or top side by the first upper surface face lateral edge 114 of the first upper surface face 110, the second upper surface lateral edge 124 of the second upper surface face 120, and least a portion of the third upper surface face lateral edge 134 of the third upper surface face 130. The forward side surface 610 may be bounded on its lower or inferior side by at least a portion of the lower nose surface lateral edge 612 of the lower nose surface 710. The forward side surface 610 may be bounded on its lower or inferior side by at least a portion of the forward side surface lower lateral edge 614. On its lower or inferior side, the forward side surface 610 is bounded at its leading edge by at least a portion of the lower nose surface lateral edge 612 of the lower nose surface 710 and by the forward side surface lower lateral edge 614. As discussed above, each of the first upper surface face lateral edge 114, second upper surface lateral edge 124, and third upper surface face lateral edge 134 may be radiused edges or sharp edges (e.g., with little to no radius, or two planar surfaces meeting at an angle). In the same way, the lower nose surface lateral edge 612 and the forward side surface lower lateral edge 614 may also be radiused edges or sharp edges (e.g., with little to no radius, or two planar surfaces meeting at an angle). In some embodiments, the forward side surface 610 may be bounded on its rear or trailing side by at least a portion of the middle side surface 620, e.g., a front or leading side or portion of the middle side surface 620. In some embodiments, the forward side surface 610 is substantially planar. In other embodiments, the forward side surface 610 is substantially curviplanar.

In some embodiments, the middle side surface 620 is bounded on its upper or top side by various structures of the wings 400 (discussed in more detail elsewhere herein). The middle side surface 620 may be bounded on its upper or top side by at least a portion of the leading wing root insertion point 442. The middle side surface 620 may be bounded on its upper or top side by at least a portion of the inferior upper leading face insertion point 447. The middle side surface 620 may be bounded on its upper or top side by at least a portion of the upper leading face root 446. In some embodiments, at its upper or superior extent, the middle side surface 620 is bounded on its leading edge by at least a portion of the leading wing root insertion point 442 and on its trailing edge by at least a portion of the inferior upper leading face insertion point 447. As shown in FIG. 6A, the middle side surface 620 transitions into or joins with the upper leading face 420 at the upper leading face root 446. In some embodiments, the middle side surface 620 transitions into the upper leading face 420 in a continuous or curviplanar fashion, such that the upper leading face 420 and the middle side surface 620 are a single, continuous, curviplanar surface. In such embodiments, the transition between the upper leading face 420 and middle side surface 620 is indistinct and more a location than a joint. In other embodiments, the middle side surface 620 transitions into the upper leading face 420 in a discontinuous fashion, e.g., at a distinct joint. In such embodiments, the middle side surface 620 may be a single planar or curviplanar surface, the upper leading face 420 may be a single and separate curviplanar or planar surface, and the middle side surface 620 may meet the upper leading face 420 at an identifiable or distinct joint or discontinuity. On its lower or inferior side, the middle side surface 620 is bounded by at least a portion of the middle side surface lower lateral edge 624. In some embodiments, the middle side surface lower lateral edge 624 may be radiused edges or sharp edges (e.g., with little to no radius, or two planar surfaces meeting at an angle). In some embodiments, the middle side surface 620 is bounded on its front or leading side by at least a portion of the forward side surface 610, e.g., a rear or trailing portions of the forward side surface 610. In some embodiments, the middle side surface 620 is bounded on its rear or trailing side by at least a portion of the rear side surface 630, e.g., at least a portion of the leading or front end or extent of the rear side surface 630. In some embodiments, the middle side surface 620 is substantially planar, e.g., substantially planar save, possibly, for the junction between the middle side surface 620 and the upper leading face 420. In such embodiments, the middle side surface 620 may be substantially planar, front to back and top to bottom, except that the middle side surface 620 may include a curviplanar portion at the upper leading face root 446. In other embodiments, the middle side surface 620 is substantially continuously or discontinuously curviplanar. In such embodiments, the middle side surface 620 may be substantially curviplanar or curved from front to back and include a curved transition where the middle side surface 620 meets the upper leading face 420 at the upper leading face root 446.

In some embodiments, the rear side surface 630 is bounded on its upper or top side by various portions of the wing 400, e.g., the wing bottom surface 500 of the wing 400, such as but not limited to various portions of the lower wing root 540 of the wing 400. The rear side surface 630 may be bounded on its upper or top side by at least a portion of the inferior upper leading face insertion point 447. The rear side surface 630 may be bounded on its upper or top side by at least a portion of the lower leading face root 448. The rear side surface 630 may be bounded on its upper or top side by at least a portion of the inferior lower leading face insertion point 449. The rear side surface 630 may be bounded on its upper or top side by at least a portion of the lower wing root 540 of the wing 400. The rear side surface 630 may be bounded on its upper or top side by at least a portion of the wing arch insertion point 544. With reference to FIG. 5C, in some embodiments, the rear side surface 630 is bounded on its upper or top side by the various portions of the wing root, including, in front-to-back order, at least one of, the inferior upper leading face insertion point 447, the lower leading face root 448, the inferior lower leading face insertion point 449, the wing bottom surface 500, and the wing arch insertion point 544. On its lower or inferior side, the rear side surface 630 is bounded at least partially by at least a portion of the rear side surface lower lateral edge 634 and the lower rear face lateral edge 244 of the heel 640. In some embodiments, at least a portion of the rear side surface 630 is bounded on its lower or bottom side by at least a portion of the rear side surface lower lateral edge 634. In some embodiments, at least a portion of the rear side surface 630 is bounded on its lower or bottom side by at least a portion of the lower rear face lateral edge 244 of the heel 640. In some embodiments, the rear side surface 630 is substantially planar. In other embodiments, the rear side surface 630 is substantially curviplanar.

The transverse aperture 340 may be located in each of the left and right rear side surfaces 630. For example, each rear side surface 630 may include one transverse aperture 340 extending through the rear side surface 630 at an angle approximately perpendicular to a vertical plane including the line of bilateral symmetry 902.

One or more individual surfaces of the side surface 600, e.g., the forward side surface 610, the middle side surface 620, and/or the rear side surface 630 may be substantially perpendicular to one or more surfaces of the upper surface 104, e.g., to one or more of the first upper surface face 110, second upper surface face 120, and/or the third upper surface face 130. Alternatively, one or more individual surface of the side surface 600, e.g., the forward side surface 610, the middle side surface 620, and/or the rear side surface 630 may extend at an angle to one or more surface of the upper surface 104, e.g., to one or more of the first upper surface face 110, the second upper surface face 120, and/or the third upper surface face 130. In some embodiments, one or more surfaces of the side surface 600 may extend away from one or more surfaces of the upper surface 104 at an angle less than ninety degrees, e.g., the bottom of the body of the curve-winged ripper point 100 (e.g., the width of the lower surface 700) may be narrower than the top of the body of the curve-winged ripper point 100 (e.g., the width of the upper surface 104). With reference to FIG. 3B, it can be seen that at least a portion of the forward side surface 610 and the middle side surface 620 extend away from the upper surface 104 at an angle less than ninety degrees such that the base of the curve-winged ripper point 100 is narrower than the top of the curve-winged ripper point 100. In some embodiments, one or more surfaces of the side surface 600 may extend away from one or more surfaces of the upper surface 104 at an angle greater than ninety degrees, e.g., the bottom of the body of the curve-winged ripper point 100 (e.g., the width of the lower surface 700) may be wider than the top of the body of the curve-winged ripper point 100 (e.g., the width of the upper surface 104). In some embodiments, one or more surfaces of the side surface 600 may extend away from one or more surface of the upper surface 104 at an angle approximately equal to ninety degrees, e.g., the bottom of the body of the curve-winged ripper point 100 (e.g., the width of the lower surface 700) may be approximately equal to the top of the body of the curve-winged ripper point 100 (e.g., the width of the upper surface 104).

Turning to FIG. 3B, the lower surface 700 of the lower nose surface 710 may be seen. The embodiment of the curve-winged ripper point 100 shown in this figure includes a number of lower surfaces and structures, including, at least, the lower nose surface 710 at the leading edge, the lower surface forward face 720 the lower surface middle face 730 and the lower surface rear face 740. As illustrated, the lower surface forward face 720 includes a lower relief 760.

The lower nose surface 710 of the lower surface 700 is defined on its front end by the nose edge 112 and a nose edge lateral point 116 on each lateral end of the nose edge 112, by a lower nose surface lateral edge 612 on each lateral side of the lower nose surface 710, and by the front or leading side of the lower surface forward face 720 on the trailing or rear end of the lower nose surface 710. The lower nose surface lateral edge 612 on each side of the lower nose surface 710 may be linear or curvilinear, which one of ordinary skill in the art will understand impacts the shape or structure of the forward side surface 610. As discussed, the nose edge 112 has a nose width 903. The rear end of the lower nose surface 710, and therefore the front end of the lower surface forward face 720, as a lower surface forward face leading width 908. In some embodiments, the lower surface forward face leading width 908 is approximately equal to the nose width 903. In other embodiments, the lower surface forward face leading width 908 is greater than the nose width 903. For example, in such embodiments, the ratio between the lower surface forward face leading width 908 and the nose width 903 is about 100%, 102%, 104%, 106%, 108%, 110%, 112%, 114%, 116%, 118%, or 120%, or any other ratio that advantageously interacts with the soil during use. In some embodiments, the ratio between the lower surface forward face leading width 908 and the nose width 903 is greater than about 100%, 102%, 104%, 106%, 108%, 110%, 112%, 114%, 116%, 118%, or 120%, or any other ratio that advantageously interacts with the soil during use. In the same way, in some embodiments, the ratio between the lower surface forward face leading width 908 and the nose width 903 is between about 100-120%, 101-118%, 102-116%, 103-114%, 104-112%, 105-110%, or 106-108%, or any other ratio that advantageously interacts with the soil during use. In some embodiments, the lower surface forward face leading width 908 is less than the nose width 903. For example, in such embodiments, the ratio between the lower surface forward face leading width 908 and the nose width 903 is about 100%, 98%, 96%, 94%, 92%, 90%, 88%, 86%, 84%, 82%, or 80%, or any other ratio that advantageously interacts with the soil during use. In some embodiments, the ratio between the lower surface forward face leading width 908 and the nose width 903 is less than about 100%, 98%, 96%, 94%, 92%, 90%, 88%, 86%, 84%, 82%, or 80%, or any other ratio that advantageously interacts with the soil during use. In the same way, in some embodiments, the ratio between the lower surface forward face leading width 908 and the nose width 903 is between about 80-100%, 82-99%, 84-98%, 86-97%, 88-96%, 90-95%, or 92-94%, or any other ratio that advantageously interacts with the soil during use.

The lower surface forward face 720 on the lower surface 700 is defined on its front or leading end by the trailing edge of the lower nose surface 710, on its rear or trailing end by the leading edge of the lower surface middle face 730, and by a forward side surface lower lateral edge 614 on each lateral side. The forward side surface lower lateral edge 614 on each side of the lower surface forward face 720 may be linear or curvilinear, which one of ordinary skill in the art will understand impacts the shape or structure of the forward side surface 610. The front end of the lower surface forward face 720 and the rear end of the lower nose surface 710 have a lower surface forward face leading width 908. The rear end of the lower surface forward face 720 and the front end of the lower surface middle face 730 have a forward lower surface middle face leading width 909. In some embodiments, the lower surface middle face leading width 909 is approximately equal to the lower surface forward face leading width 908. In other embodiments, including that shown in FIG. 3B, the lower surface middle face leading width 909 is less than the lower surface forward face leading width 908. For example, in such embodiments, the ratio between the lower surface middle face leading width 909 and the lower surface forward face leading width 908 is about 100%, 98%, 96%, 94%, 92%, 90%, 88%, 86%, 84%, 82%, or 80%, or any other ratio that advantageously interacts with the soil during use. In some embodiments, the ratio between the lower surface middle face leading width 909 and the lower surface forward face leading width 908 is less than about 100%, 98%, 96%, 94%, 92%, 90%, 88%, 86%, 84%, 82%, or 80%, or any other ratio that advantageously interacts with the soil during use. In some embodiments, the ratio between the lower surface middle face leading width 909 and the lower surface forward face leading width 908 is between about 80-100%, 82-99%, 84-98%, 86-97%, 88-96%, 90-95%, or 92-94%, or any other ratio that advantageously interacts with the soil during use. In other embodiments, the lower surface middle face leading width 909 is greater than the lower surface forward face leading width 908. For example, in such embodiments, the ratio between the lower surface middle face leading width 909 and the lower surface forward face leading width 908 is about 100%, 102%, 104%, 106%, 108%, 110%, 112%, 114%, 116%, 118%, or 120%, or any other ratio that advantageously interacts with the soil during use. In some embodiments, the ratio between the lower surface middle face leading width 909 and the lower surface forward face leading width 908 is greater than about 100%, 102%, 104%, 106%, 108%, 110%, 112%, 114%, 116%, 118%, or 120%, or any other ratio that advantageously interacts with the soil during use. In the same way, in some embodiments, the ratio between the lower surface middle face leading width 909 and the lower surface forward face leading width 908 is between about 100-120%, 101-118%, 102-116%, 103-114%, 104-112%, 105-110%, or 106-108%, or any other ratio that advantageously interacts with the soil during use.

As shown in FIG. 3B, the lower surface forward face 720 may include a lower relief 760. The lower relief 760 is defined by a lower relief leading edge 768, a lower relief trailing edge 762 and lower relief lateral edges 764. The lower relief 760 may be inset into the lower surface forward face 720 of the lower surface 700 by a depth. As will be understood by the skilled artisan, the lower relief 760 may have any of a number of structural characteristics. For example, the lower relief trailing edge 762 and the lower relief leading edge 768 may be oriented at an angle substantially perpendicular to the line of bilateral symmetry 902. In the same way the lower relief lateral edges 764 may each be generally parallel to the line of bilateral symmetry 902. Each lower relief lateral edge 764 may be linear or curvilinear. As shown, the lower relief lateral edges 764 are gently bowed, e.g., not wholly linear and lacking right angles. Though, other types and structures of reliefs may be used. In some embodiments, no lower relief 760 is included in the lower surface 700.

The lower surface middle face 730 on the lower surface 700 is defined on its front or leading end by the trailing edge of the lower surface forward face 720, on its rear or trailing end by the leading edge of the lower surface rear face 740, and by a middle side surface lower lateral edge 624 on each lateral side. The middle side surface lower lateral edge 624 on each side of the lower surface middle face 730 may be linear or curvilinear (the embodiment shown in FIG. 3B depicts a substantially curvilinear middle side surface lower lateral edge 624), which one of ordinary skill in the art will understand impacts the shape or structure of the middle side surface 620. The front end of the lower surface middle face 730 and the rear end of the lower surface forward face 720 have a lower surface middle face leading width 909. The rear end of the lower surface middle face 730 and the front end of the lower surface rear face 740 have a lower surface rear face leading width 910. In some embodiments, the lower surface rear face leading width 910 is approximately equal to the lower surface middle face leading width 909. In other embodiments, including that shown in FIG. 3B, the lower surface rear face leading width 910 is greater than the lower surface middle face leading width 909. For example, in such embodiments, the ratio between the lower surface rear face leading width 910 and the lower surface middle face leading width 909 is about 100%, 102%, 104%, 106%, 108%, 110%, 112%, 114%, 116%, 118%, or 120%, or any other ratio that advantageously interacts with the soil during use. In some embodiments, the ratio between the lower surface rear face leading width 910 and the lower surface middle face leading width 909 is greater than about 100%, 102%, 104%, 106%, 108%, 110%, 112%, 114%, 116%, 118%, or 120%, or any other ratio that advantageously interacts with the soil during use. In the same way, in some embodiments, the ratio between the lower surface rear face leading width 910 and the lower surface middle face leading width 909 is between about 100-120%, 101-118%, 102-116%, 103-114%, 104-112%, 105-110%, or 106-108%, or any other ratio that advantageously interacts with the soil during use. In other embodiments, the lower surface rear face leading width 910 is less than the lower surface middle face leading width 909. For example, in such embodiments, the ratio between the lower surface rear face leading width 910 and the lower surface middle face leading width 909 is about 100%, 98%, 96%, 94%, 92%, 90%, 88%, 86%, 84%, 82%, or 80%, or any other ratio that advantageously interacts with the soil during use. In some embodiments, the ratio between the lower surface rear face leading width 910 and the lower surface middle face leading width 909 is less than about 100%, 98%, 96%, 94%, 92%, 90%, 88%, 86%, 84%, 82%, or 80%, or any other ratio that advantageously interacts with the soil during use. In some embodiments, the ratio between the lower surface rear face leading width 910 and the lower surface middle face leading width 909 is between about 80-100%, 82-99%, 84-98%, 86-97%, 88-96%, 90-95%, or 92-94%, or any other ratio that advantageously interacts with the soil during use.

The lower surface rear face 740 on the lower surface 700 is defined on its front or leading end by the trailing end of the lower surface middle face 730, on its rear or trailing end by the lower or leading edge of the rear surface 204, and by a rear side surface lower lateral edge 634 on each lateral side. The rear side surface lower lateral edge 634 on each side of the lower surface rear face 740 may be linear or curvilinear, which one or ordinary skill in the art will understand impacts the shape or structure of the rear side surface 630. The front end of the lower surface rear face 740 and the rear end of the lower surface middle face 730 have a lower surface rear face leading width 910. The rear end of the lower surface rear face 740 and the lower or leading edge of the rear surface 204, e.g., the lower rear face bottom edge 246, have a lower surface rear face trailing width 911. In some embodiments, the lower surface rear face trailing width 911 is approximately equal to the lower surface rear face leading width 910. In other embodiments, the lower surface rear face trailing width 911 is greater than the lower surface rear face leading width 910. For example, in some embodiments, the ratio between the lower surface rear face trailing width 911 and the lower surface rear face leading width 910 is about 100%, 102%, 104%, 106%, 108%, 110%, 112%, 114%, 116%, 118%, or 120%, or any other ratio that advantageously interacts with the soil during use. In some embodiments, the ratio between the lower surface rear face trailing width 911 and the lower surface rear face leading width 910 is greater than about 100%, 102%, 104%, 106%, 108%, 110%, 112%, 114%, 116%, 118%, or 120%, or any other ratio that advantageously interacts with the soil during use. In the same way, in some embodiments, the ratio between the lower surface rear face trailing width 911 and the lower surface rear face leading width 910 is between about 100-120%, 101-118%, 102-116%, 103-114%, 104-112%, 105-110%, or 106-108%, or any other ratio that advantageously interacts with the soil during use. In other embodiments, the lower surface rear face trailing width 911 is less than the lower surface rear face leading width 910. For example, in some embodiments, the ratio between the lower surface rear face trailing width 911 and the lower surface rear face leading width 910 is about 100%, 98%, 96%, 94%, 92%, 90%, 88%, 86%, 84%, 82%, or 80%, or any other ratio that advantageously interacts with the soil during use. In some embodiments, the ratio between the lower surface rear face trailing width 911 and the lower surface rear face leading width 910 is less than about 100%, 98%, 96%, 94%, 92%, 90%, 88%, 86%, 84%, 82%, or 80%, or any other ratio that advantageously interacts with the soil during use. In some embodiments, the ratio between the lower surface rear face trailing width 911 and the lower surface rear face leading width 910 is between about 80-100%, 82-99%, 84-98%, 86-97%, 88-96%, 90-95%, or 92-94%, or any other ratio that advantageously interacts with the soil during use.

With reference to FIG. 6B, the heel radius 970 of the heel 640 has a measurement in inches of less than about 5, 45. 4, 3.5, 3, 2.5, 2, 1.5, or 1, or any other measurement that advantageously interacts with the soil during use. In other embodiments, the heel radius 970 of the heel 640 has a measurement in inches of about 5, 45, 4, 3.5, 3, 2.5, 2, 1.5, or 1, or any other measurement that advantageously interacts with the soil during use. In still other embodiments, the heel radius 970 of the heel 640 has a measurement in inches of between about 2-5, 2.25-4.75, 2.5-4.5, or 2.75-4.25 or any other measurement that advantageously interacts with the soil during use.

At its rear end, the lower surface rear face 740 is bounded by the lower or leading edge of the rear surface 204 at the lower rear face bottom edge 246. Turning to FIGS. 3A, 4B, and 5C, the rear surface 204 may be a single curviplanar surface that extends from the third upper surface joint 242 around the rear or trailing end of the curve-winged ripper point 100 and connects to the lower surface rear face 740 at the lower rear face bottom edge 246. In some embodiments, the rear surface 204 includes a number of discrete faces. In such embodiments, the rear surface 204 may include a number of discrete faces that is equal to 1, 2, 3, 4, 5, or 6. In embodiments having a number of discrete faces, the faces may be: all curviplanar, all planar, or some curviplanar and some planar.

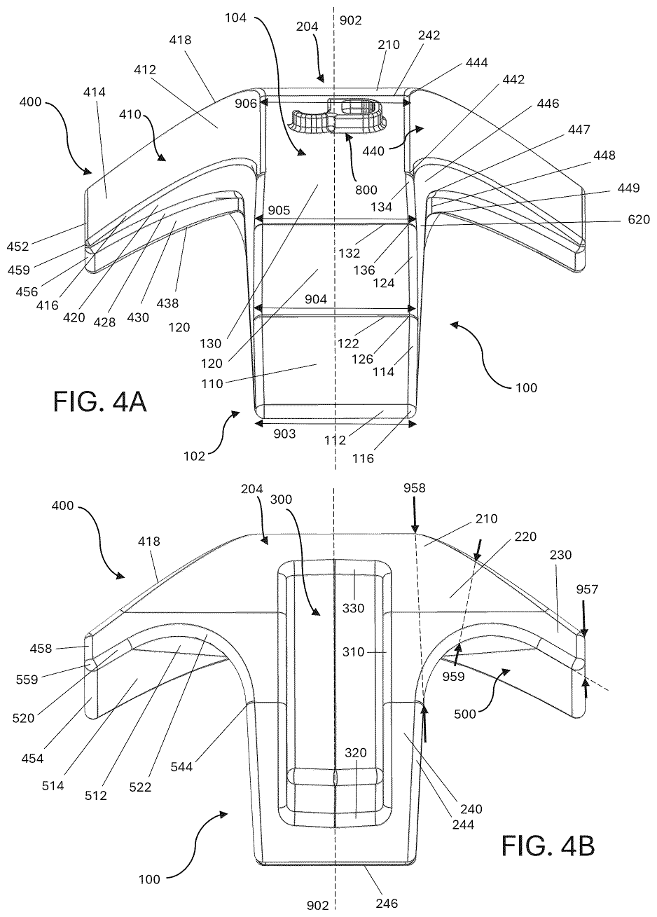

As shown in FIGS. 4A and 4B, the rear surface 204 connects to the third upper surface face 130 of the upper surface 104 at the third upper surface joint 242, which has been described elsewhere herein. In some embodiments, the third upper surface joint 242 is a discrete joint, e.g., specifically identifiable. In some embodiments, the third upper surface joint 242 is identifiable by the trailing wing root insertion point 444, or where the third upper surface face lateral edge 134 transition from a linear portion to the curvilinear wing top surface trailing edge 418 of the wing 400 (discussed elsewhere herein). Extending rearward from the third upper surface joint 242, the rear surface 204 includes a rear upper shoulder 210, a rear middle shoulder 220, a rear wing face 230, and a lower rear face 240, which wraps around the heel 640 of the curve-winged ripper point 100. As shown in FIG. 4B, the outermost portions of the rear upper shoulder 210, the rear middle shoulder 220, and the rear wing face 230 may form the rear surface of the wings 400 of the curve-winged ripper point 100.

The rear surface 204 is bounded by edges on one or more sides. For example, the rear surface 204 may be bounded at its upper and forward end by the third upper surface joint 242, where the rear upper shoulder 210 of the rear surface 204 meets the upper surface 104. The rear surface 204 may be bounded at its lower end by the lower rear face bottom edge 246, where rear upper shoulder 210 of the rear surface 204 meets the lower surface rear face 740. With reference to FIG. 4B, the rear upper shoulder 210 of the rear surface 204 may be bounded by the curvilinear wing top surface trailing edge 418. In some embodiments, the wing top surface trailing edge 418 is a radiused joint (e.g., a convex radiused joint). In other embodiments, the wing top surface trailing edge 418 is a sharp joint (e.g., with little to no radius). The wing top surface trailing edge 418 may begin at the trailing wing root insertion point 444, which may begin at the end of the third upper surface face lateral edge 134. The wing top surface trailing edge 418 may begin where the third upper surface joint 242 intersects the third upper surface face lateral edge 134, which, as shown in FIG. 4A, may be coincident with the trailing wing root insertion point 444. The rear middle shoulder 220 may also be bounded by the wing top surface trailing edge 418. The rear wing face 230 may be bounded on its upper side or extent by the wing top surface trailing edge 418, on its lateral or outer extent by the wingtip lateral face trailing edge 458, and on its lower side or extent by the wing bottom surface outer trailing edge 520. In some embodiments, the wingtip lateral face trailing edge 458 is a radiused joint (e.g., a convex radiused joint). In other embodiments, the wingtip lateral face trailing edge 458 is a sharp joint (e.g., with little to no radius). In some embodiments, the wing bottom surface outer trailing edge 520 is a radiused joint (e.g., a convex radiused joint). In other embodiments, the wing bottom surface outer trailing edge 520 is a sharp joint (e.g., with little to no radius). One or more (at least one of) of the rear middle shoulder 220 and the rear wing face 230 may also be at least partially bounded by the trailing wing arch 522, which extends along the rear of the wing 400, forming the trailing rear edge of the wing 400, from the inner portion or extent of the wing bottom surface outer trailing edge 520 to the wing arch insertion point 544. In some embodiments, the trailing wing arch 522 is a radiused joint (e.g., a convex radiused joint). In other embodiments, the trailing wing arch 522 is a sharp joint (e.g., with little to no radius). The lower portion of the rear surface 204, or the lower rear face 240, may be bounded on each lateral side by the lower rear face lateral edges 244. In some embodiments, the lower rear face lateral edge 244 is a radiused joint (e.g., a convex radiused joint). In other embodiments, the lower rear face lateral edge 244 is a sharp joint (e.g., with little to no radius).

As discussed elsewhere herein, the rear surface 204 includes the shank socket 300 which is bounded on its upper extend by the shank socket upper edge 330, on its lower extent by the shank socket lower edge 320, and on each lateral sides by the shank socket lateral edges 310.

In some embodiments, the lower surface forward face leading width 908 is approximately equal to the nose width 903. In some embodiments, the lower surface forward face leading width 908 is greater than the nose width 903. For example, in such embodiments, the ratio between the lower surface forward face leading width 908 and the nose width 903 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface forward face leading width 908 is less than the nose width 903. For example, in some embodiments, the ratio between the lower surface forward face leading width 908 and the nose width 903 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface forward face leading width 908 is approximately equal to the first joint width 904. In some embodiments, the lower surface forward face leading width 908 is greater than the first joint width 904. For example, in such embodiments, the ratio between the lower surface forward face leading width 908 and the first joint width 904 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface forward face leading width 908 is less than the first joint width 904. For example, in some embodiments, the ratio between the lower surface forward face leading width 908 and the first joint width 904 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface forward face leading width 908 is approximately equal to the second joint width 905. In some embodiments, the lower surface forward face leading width 908 is greater than the second joint width 905. For example, in such embodiments, the ratio between the lower surface forward face leading width 908 and the second joint width 905 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface forward face leading width 908 is less than the second joint width 905. For example, in some embodiments, the ratio between the lower surface forward face leading width 908 and the second joint width 905 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface forward face leading width 908 is approximately equal to the third joint width 906. In some embodiments, the lower surface forward face leading width 908 is greater than the third joint width 906. For example, in such embodiments, the ratio between the lower surface forward face leading width 908 and the third joint width 906 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface forward face leading width 908 is less than the third joint width 906. For example, in some embodiments, the ratio between the lower surface forward face leading width 908 and the third joint width 906 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface forward face leading width 908 is approximately equal to the heel width 907. In some embodiments, the lower surface forward face leading width 908 is greater than the heel width 907. For example, in such embodiments, the ratio between the lower surface forward face leading width 908 and the heel width 907 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface forward face leading width 908 is less than the heel width 907. For example, in some embodiments, the ratio between the lower surface forward face leading width 908 and the heel width 907 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use.

In some embodiments, the lower surface middle face leading width 909 is approximately equal to the nose width 903. In some embodiments, the lower surface middle face leading width 909 is greater than the nose width 903. For example, in such embodiments, the ratio between the lower surface middle face leading width 909 and the nose width 903 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface middle face leading width 909 is less than the nose width 903. For example, in some embodiments, the ratio between the lower surface middle face leading width 909 and the nose width 903 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface middle face leading width 909 is approximately equal to the first joint width 904. In some embodiments, the lower surface middle face leading width 909 is greater than the first joint width 904. For example, in such embodiments, the ratio between the lower surface middle face leading width 909 and the first joint width 904 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface middle face leading width 909 is less than the first joint width 904. For example, in some embodiments, the ratio between the lower surface middle face leading width 909 and the first joint width 904 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface middle face leading width 909 is approximately equal to the second joint width 905. In some embodiments, the lower surface middle face leading width 909 is greater than the second joint width 905. For example, in such embodiments, the ratio between the lower surface middle face leading width 909 and the second joint width 905 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface middle face leading width 909 is less than the second joint width 905. For example, in some embodiments, the ratio between the lower surface middle face leading width 909 and the second joint width 905 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface middle face leading width 909 is approximately equal to the third joint width 906. In some embodiments, the lower surface middle face leading width 909 is greater than the third joint width 906. For example, in such embodiments, the ratio between the lower surface middle face leading width 909 and the third joint width 906 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface middle face leading width 909 is less than the third joint width 906. For example, in some embodiments, the ratio between the lower surface middle face leading width 909 and the third joint width 906 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface middle face leading width 909 is approximately equal to the heel width 907. In some embodiments, the lower surface middle face leading width 909 is greater than the heel width 907. For example, in such embodiments, the ratio between the lower surface middle face leading width 909 and the heel width 907 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface middle face leading width 909 is less than the heel width 907. For example, in some embodiments, the ratio between the lower surface middle face leading width 909 and the heel width 907 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use.

In some embodiments, the lower surface rear face leading width 910 is approximately equal to the nose width 903. In some embodiments, the lower surface rear face leading width 910 is greater than the nose width 903. For example, in such embodiments, the ratio between the lower surface rear face leading width 910 and the nose width 903 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face leading width 910 is less than the nose width 903. For example, in some embodiments, the ratio between the lower surface rear face leading width 910 and the nose width 903 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face leading width 910 is approximately equal to the first joint width 904. In some embodiments, the lower surface rear face leading width 910 is greater than the first joint width 904. For example, in such embodiments, the ratio between the lower surface rear face leading width 910 and the first joint width 904 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face leading width 910 is less than the first joint width 904. For example, in some embodiments, the ratio between the lower surface rear face leading width 910 and the first joint width 904 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face leading width 910 is approximately equal to the second joint width 905. In some embodiments, the lower surface rear face leading width 910 is greater than the second joint width 905. For example, in such embodiments, the ratio between the lower surface rear face leading width 910 and the second joint width 905 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face leading width 910 is less than the second joint width 905. For example, in some embodiments, the ratio between the lower surface rear face leading width 910 and the second joint width 905 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face leading width 910 is approximately equal to the third joint width 906. In some embodiments, the lower surface rear face leading width 910 is greater than the third joint width 906. For example, in such embodiments, the ratio between the lower surface rear face leading width 910 and the third joint width 906 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face leading width 910 is less than the third joint width 906. For example, in some embodiments, the ratio between the lower surface rear face leading width 910 and the third joint width 906 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face leading width 910 is approximately equal to the heel width 907. In some embodiments, the lower surface rear face leading width 910 is greater than the heel width 907. For example, in such embodiments, the ratio between the lower surface rear face leading width 910 and the heel width 907 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face leading width 910 is less than the heel width 907. For example, in some embodiments, the ratio between the lower surface rear face leading width 910 and the heel width 907 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use.

In some embodiments, the lower surface rear face trailing width 911 is approximately equal to the nose width 903. In some embodiments, the lower surface rear face trailing width 911 is greater than the nose width 903. For example, in such embodiments, the ratio between the lower surface rear face trailing width 911 and the nose width 903 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face trailing width 911 is less than the nose width 903. For example, in some embodiments, the ratio between the lower surface rear face trailing width 911 and the nose width 903 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face trailing width 911 is approximately equal to the first joint width 904. In some embodiments, the lower surface rear face trailing width 911 is greater than the first joint width 904. For example, in such embodiments, the ratio between the lower surface rear face trailing width 911 and the first joint width 904 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face trailing width 911 is less than the first joint width 904. For example, in some embodiments, the ratio between the lower surface rear face trailing width 911 and the first joint width 904 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face trailing width 911 is approximately equal to the second joint width 905. In some embodiments, the lower surface rear face trailing width 911 is greater than the second joint width 905. For example, in such embodiments, the ratio between the lower surface rear face trailing width 911 and the second joint width 905 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face trailing width 911 is less than the second joint width 905. For example, in some embodiments, the ratio between the lower surface rear face trailing width 911 and the second joint width 905 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face trailing width 911 is approximately equal to the third joint width 906. In some embodiments, the lower surface rear face trailing width 911 is greater than the third joint width 906. For example, in such embodiments, the ratio between the lower surface rear face trailing width 911 and the third joint width 906 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face trailing width 911 is less than the third joint width 906. For example, in some embodiments, the ratio between the lower surface rear face trailing width 911 and the third joint width 906 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the lower surface rear face trailing width 911 is approximately equal to the heel width 907. In some embodiments, the lower surface rear face trailing width 911 is greater than the heel width 907. For example, in such embodiments, the ratio between the lower surface rear face trailing width 911 and the heel width 907 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the lower surface rear face trailing width 911 is less than the heel width 907. For example, in some embodiments, the ratio between the lower surface rear face trailing width 911 and the heel width 907 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use.

In some embodiments, the heel width 907 is approximately equal to the nose width 903. In some embodiments, the heel width 907 is greater than the nose width 903. For example, in such embodiments, the ratio between the heel width 907 and the nose width 903 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the heel width 907 is less than the nose width 903. For example, in some embodiments, the ratio between the heel width 907 and the nose width 903 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the heel width 907 is approximately equal to the first joint width 904. In some embodiments, the heel width 907 is greater than the first joint width 904. For example, in such embodiments, the ratio between the heel width 907 and the first joint width 904 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the heel width 907 is less than the first joint width 904. For example, in some embodiments, the ratio between the heel width 907 and the first joint width 904 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the heel width 907 is approximately equal to the second joint width 905. In some embodiments, the heel width 907 is greater than the second joint width 905. For example, in such embodiments, the ratio between the heel width 907 and the second joint width 905 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the heel width 907 is less than the second joint width 905. For example, in some embodiments, the ratio between the heel width 907 and the second joint width 905 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use. In some embodiments, the heel width 907 is approximately equal to the third joint width 906. In some embodiments, the heel width 907 is greater than the third joint width 906. For example, in such embodiments, the ratio between the heel width 907 and the third joint width 906 may be: about 100%, 102%, 104%, 106%, 108%, 110%, 112%, 114%, 116%, 118%, or 120%; greater than about 100%, 102%, 104%, 106%, 108%, 110%, 112%, 114%, 116%, 118%, or 120%; between about 100-120%, 101-118%, 102-116%, 103-114%, 104-112%, 105-110%, or 106-108%; or any other ratio that advantageously interacts with the soil during use. In other embodiments, the heel width 907 is less than the third joint width 906. For example, in some embodiments, the ratio between the heel width 907 and the third joint width 906 may be: about 100%, 98%, 96%, 94%, 92%, 90%, 88%, 86%, 84%, 82%, or 80%; less than about 100%, 98%, 96%, 94%, 92%, 90%, 88%, 86%, 84%, 82%, or 80%; between about 80-100%, 82-99%, 84-98%, 86-97%, 88-96%, 90-95%, or 92-94%; or any other ratio that advantageously interacts with the soil during use.

With reference to FIGS. 3A and 3B, the curve-winged ripper point 100 includes a wing 400 on the left lateral side and a wing 400 on the right lateral side. The right and left wings 400 may be bilaterally symmetrical about the line of bilateral symmetry 902. Therefore, the wings 400 may be discussed individually or in the singular. One of ordinary skill in the art will understand that the structures of the curve-winged ripper point 100 may be symmetrical or mirror copies of each other and that what is said or described with respect to one such structure applies to other, mirror, or symmetrical structures.

The rear surface 204 of the body of the curve-winged ripper point 100 may form all or a portion of the rear side of the wing 400. As shown in FIGS. 3A and 4B, the rear upper shoulder 210 of the rear surface 204 may form the upper portion of the rear surface of the wing 400, the rear middle shoulder 220 of the rear surface 204 may form a middle portion of the rear surface of the wing 400, and the rear wing face 230 may form the rear surface of the outer portion of the wing 400.

The upper trailing edge of the wing 400 is formed by the wing top surface trailing edge 418. The wing top surface trailing edge 418 may extend from or begin at any of a number of locations on the body of the curve-winged ripper point 100. Generally speaking, where the wing top surface trailing edge 418 begins may be referred to as the trailing wing root insertion point 444. For example, the wing top surface trailing edge 418 may begin where the third upper surface joint 242 intersects with the third upper surface face lateral edge 134. The wing top surface trailing edge 418 may begin where the third upper surface face lateral edge 134 of the third upper surface face 130 ends on its upper extent. The wing top surface trailing edge 418 may begin where the third upper surface face lateral edge 134 of the third upper surface face 130 becomes nonlinear.

The wing 400 attaches (though, the attachment may be monolithic or otherwise) to the body of the curve-winged ripper point 100 at the wing root 440. The various structures of the wing root 440 include various root structures on the front of the wing 400, various structures on the top of the wing 400, various root structures on the rear of the wing 400, and various structures on the bottom of the wing 400.

FIG. 4B illustrates the various structures of the rear of the wing 400. As discussed, the rear surface 204, including at least portions of at least one of the rear upper shoulder 210, rear middle shoulder 220, and rear wing face 230 may form the rear surface of the wing 400. The wing root 440 as to the rear of the wing 400 begins on its upper side at the trailing wing root insertion point 444 and on its lower side at the wing arch insertion point 544. As shown in FIG. 4B, the rear of the wing root 440 has a wing root thickness 958. The wing root thickness 958 may be defined as the distance between the trailing wing root insertion point 444 and the wing arch insertion point 544. The wing root thickness 958 may also be the largest dimension of the wing root 440. As shown in FIG. 4B, the wing 400 also has a mid-wing thickness 959 and a wingtip thickness 957. The mid-wing thickness 959 of the wing 400 is a thickness of the wing 400 laterally between the innermost extent of the wing 400 or the wing root 440, e.g., the line coextensive with the wing root thickness 958 (shown in FIG. 4B as a dashed line), and the outermost extent of the wing 400, e.g., the wingtip lateral face trailing edge 458. In some embodiments, the mid-wing thickness 959 is greater than the wing root thickness 958. In some embodiments, the mid-wing thickness 959 is approximately equal to the mid-wing thickness 959. In other embodiments, including that shown in FIG. 4B, the mid-wing thickness 959 is less than the wing root thickness 958. For example, in such embodiments, the ratio between the mid-wing thickness 959 and the wing root thickness 958 may be about 95%, 92.5%, 90%, 87.5, 85%, 80%, 75%, 72.5%, 70%, 67.5%, 65%, 62.5%, 60%, 57.5%, 55%, 52.5%, 50%, 47.5%, 45%, 42.5%, 40%, 37.5%, 35%, 32.5%, 30%, 27.5%, 25%, 22.5%, or 20%, or any other ratio that advantageously interacts with the soil during use. In some embodiments, the ratio between the mid-wing thickness 959 and the wing root thickness 958 is less than about 95%, 92.5%, 90%, 87.5, 85%, 80%, 75%, 72.5%, 70%, 67.5%, 65%, 62.5%, 60%, 57.5%, 55%, 52.5%, 50%, 47.5%, 45%, 42.5%, 40%, 37.5%, 35%, 32.5%, 30%, 27.5%, 25%, 22.5%, or 20%, or any other ratio that advantageously interacts with the soil during use. In some embodiments, the ratio between the mid-wing thickness 959 and the wing root thickness 958 is between about 15-95%, 17.5-92.5%, 20-90%, 22.5-87.5%, 25-85%, 27.5-82.5%, 30-80%, 32.5-77.5%, 35-75%, 37.5-72.5%, 40-70%, 42.5-67.5%, 45-65%, 47.5-62.5%, 50-60%, or 52.5-57.5%, or any other ratio that advantageously interacts with the soil during use. The wingtip thickness 957 of the wing 400 is a thickness of the wing 400 at the outermost extent of the wing 400, e.g., the wingtip lateral face trailing edge 458. In some embodiments, the 9257 is greater than the mid-wing thickness 959. Ise, the wingtip thickness 957 is approximately equal of the mid-wing thickness 959. In other embodiments, including that shown in FIG. 4B, the wingtip thickness 957 is less than the mid-wing thickness 959. For example, in such embodiments, the ratio between the wingtip thickness 957 and the mid-wing thickness 959 may be about 95%, 92.5%, 90%, 87.5, 85%, 80%, 75%, 72.5%, 70%, 67.5%, 65%, 62.5%, 60%, 57.5%, 55%, 52.5%, 50%, 47.5%, 45%, 42.5%, 40%, 37.5%, 35%, 32.5%, 30%, 27.5%, 25%, 22.5%, 20%, 17.5%, 15%, 12.5%, or 10%, or any other ratio that advantageously interacts with the soil during use. In some embodiments, the ratio between the wingtip thickness 957 and the mid-wing thickness 959 is less than about 95%, 92.5%, 90%, 87.5, 85%, 80%, 75%, 72.5%, 70%, 67.5%, 65%, 62.5%, 60%, 57.5%, 55%, 52.5%, 50%, 47.5%, 45%, 42.5%, 40%, 37.5%, 35%, 32.5%, 30%, 27.5%, 25%, 22.5%, 20%, 17.5%, 15%, 12.5%, or 10%, or any other ratio that advantageously interacts with the soil during use. In some embodiments, the ratio between the wingtip thickness 957 and the mid-wing thickness 959 is between about 10-90%, 12.5-87.5%, 15-85%, 17.5-82.5%, 20-80%, 22.5-77.5%, 25-75%, 27.5-72.5%, 30-70%, 32.5-67.5%, 35-65%, 37.5-62.5%, 40-60%, 42.5-57.5%, 45-55%, 47.5-52.5%, or any other ratio that advantageously interacts with the soil during use.

FIG. 3A illustrates the upper surfaces of the wing 400. The wing top surface 410 of the wing 400 extends away from the body of the curve-winged ripper point 100 beginning at the wing root 440. The front of the wing top surface 410 is defined by the wing top surface leading edge 416. And, as discussed elsewhere herein, the rear of the wing top surface 410 is defined by the wing top surface trailing edge 418. The wing top surface leading edge 416 begins or extends away from the body of the curve-winged ripper point 100 or the wing root 440 at the leading wing root insertion point 442. The wing top surface leading edge 416 ends at the lateral edge of the wing 400, e.g., where the wing top surface leading edge 416 intersects with the wingtip lateral face leading edge 456 at the outer leading point 459. The wing top surface trailing edge 418 begins or extends away from the body of the curve-winged ripper point 100 or the wing root 440 at the trailing wing root insertion point 444. The wing top surface trailing edge 418 ends at the lateral edge of the wing 400, e.g., where the wing top surface trailing edge 418 intersects with the wingtip lateral face trailing edge 458. The wing top surface 410 of the wing 400 generally includes an inner wing top surface 412 and an outer wing top surface 414. In some embodiments, the inner wing top surface 412 is a substantially planar surface. In other embodiments, the inner wing top surface 412 is a substantially curviplanar surface. In still other embodiments, the inner wing top surface 412 includes both planar and curviplanar portions. In some embodiments, the outer wing top surface 414 is a substantially planar surface. In other embodiments, the outer wing top surface 414 is a substantially curviplanar surface. In still other embodiments, the outer wing top surface 414 includes both planar and curviplanar portions. The wing 400 may have any of a number of outer lateral shapes. However, the embodiment of the curve-winged ripper point 100 shown in FIG. 3A includes a flat outer edge that is generally parallel to the body of the curve-winged ripper point 100, in other words, the outermost surface of the wing 400 (or the wingtip lateral face 450) may be substantially parallel to at least a portion of the side surface 600 (e.g., one or more of the forward side surface 610, middle side surface 620, or the rear side surface 630) of the body of the curve-winged ripper point 100. In some embodiments, the lateral outer edge of the wing top surface 410, e.g., the wingtip lateral face upper edge 452 may be substantially parallel to one or more of the third upper surface face lateral edge 134 and any surface of the side surface 600 (e.g., the forward side surface 610, middle side surface 620, or rear side surface 630).

FIG. 5C illustrates the wing bottom surface 500 of the wing 400. The wing bottom surface 500 of the wing 400 extends away from the body of the curve-winged ripper point 100 beginning at the lower wing root 540. The front of the wing bottom surface 500 is defined by the lower leading face lower edge 438. And, the rear of the wing bottom surface 500 is defined by the wing bottom surface outer trailing edge 520 and the trailing wing arch 522. The lower leading face lower edge 438 begins or extends away from the body of the curve-winged ripper point 100 or the lower wing root 540 at the inferior lower leading face insertion point 449. The lower leading face lower edge 438 ends at the lateral edge of the wing 400, e.g., where the lower leading face lower edge 438 intersects with the wingtip lateral face leading edge 456. The trailing wing arch 522 begins or extends away from the body of the curve-winged ripper point 100 or the lower wing root 540 at the wing arch insertion point 544. The trailing wing arch 522 ends where the lateral extent of the trailing wing arch 522 joins with the inner end of the wing bottom surface outer trailing edge 520. In some embodiments, the trailing wing arch 522 is entirely or substantially curvilinear and the wing bottom surface outer trailing edge 520 is entirely or substantially linear. In such embodiments, the trailing wing arch 522 ends on its lateral extent and the trailing wing arch 522 begins (e.g., the trailing wing arch 522 meets the wing bottom surface outer trailing edge 520) where the rear ends of the wing 400 transitions from curvilinear to linear. The trailing wing arch 522 ends at the lateral edge of the wing 400, e.g., where the trailing wing arch 522 intersects with the wingtip lateral face trailing edge 458 at the outer leading point 459. The wing bottom surface 500 of the wing 400 generally includes an inner wing bottom surface 512 and an outer wing bottom surface 514. In some embodiments, the inner wing bottom surface 512 is a substantially planar surface. In other embodiments, the inner wing bottom surface 512 is a substantially curviplanar surface. In yet other embodiments, the inner wing bottom surface 512 includes both planar and curviplanar portions. In some embodiments, the outer wing bottom surface 514 is a substantially planar surface. In other embodiments, the outer wing bottom surface 514 is a substantially curviplanar surface. In yet other embodiments, the outer wing bottom surface 514 includes both planar and curviplanar portions. In some embodiments, the lateral outer edge of the wing bottom surface 500, e.g., the wingtip lateral face lower edge 454 may be substantially parallel to one or more of the third upper surface face lateral edge 134 and any surface of the side surface 600 (e.g., the forward side surface 610, middle side surface 620, or rear side surface 630).

FIGS. 2 and 4A illustrate the leading portions(s) of the wing 400. The wing 400 may have a number of surfaces forming the leading face or faces of the wing 400. The curve-winged ripper point 100 illustrated in FIG. 2 includes two separate leading faces, an upper leading face 420 and a lower leading face 430. However, the wing 400 may include different numbers of leading faces. In some embodiments, the wing 400 has a single or one leading face. In other embodiments, the wing 400 includes a number of leading faces equal to 2, 3, 4, or 5, or any other number of leading faces that advantageously interacts with the soil during use. Turning again to FIG. 2, the front aspect of the wing 400 includes an upper leading face 420 and a lower leading face 430.

The upper leading face 420 of the wing 400 extends away from, e.g., one or more of upwards and outwards from the middle side surface 620 of the side surface 600 at the upper leading face root 446. As discussed elsewhere herein, the upper leading face 420 may be continuous with the middle side surface 620 or the upper leading face 420 may be discontinuous from the middle side surface 620 (the embodiment shown in FIG. 2 shows a continuous, curviplanar surface). The upper leading face 420 is bounded on its upper extent by the wing top surface leading edge 416, which as discussed begins at the leading wing root insertion point 442 and ends at the lateral edge of the wing 400, e.g., where the wing top surface leading edge 416 meets the wingtip lateral face leading edge 456. On its lower side, the upper leading face 420 is bounded by the upper leading face lower edge 428. The upper leading face lower edge 428 begins on the side surface 600 at the inferior upper leading face insertion point 447. In some embodiments, the inferior upper leading face insertion point 447 begins at a point on the joint between the middle side surface 620 and the rear side surface 630 (e.g., the junction between the middle side surface 620 and the rear side surface 630). In other embodiments, the inferior upper leading face insertion point 447 begins as a point on the curviplanar or planar surface that is the rear side surface 630. The upper leading face lower edge 428 extends away from the side surface 600, e.g., away from the inferior upper leading face insertion point 447, and ends at the lateral edge of the wing 400. In some embodiments, the upper leading face lower edge 428 ends at the same point where the wing top surface leading edge 416 meets the lateral face of the wing 400, e.g., where the wing top surface leading edge 416 meets the wingtip lateral face leading edge 456. In some embodiments, both the upper leading face lower edge 428 and the wing top surface leading edge 416 end at the outer leading point 459. One or more of the upper leading face lower edge 428 and the wing top surface leading edge 416 may end at the forwardmost point on the outer lateral edge of the wing 400.

The lower leading face 430 of the wing 400 extends away from, e.g., one or more of upwards and outwards from the rear side surface 630 of the side surface 600 at the lower leading face root 448. The lower leading face 430 may be continuous with the rear side surface 630 or the lower leading face 430 may be discontinuous from the rear side surface 630 (the embodiment shown in FIG. 2 shows a discontinuous connection where the substantially curviplanar lower leading face 430 meets with the substantially planar rear side surface 630 at the lower leading face root 448). The lower leading face 430 is bounded on its upper extent by the upper leading face lower edge 428, which as discussed begins at the inferior upper leading face insertion point 447 and ends at the lateral edge of the wing 400. On its lower side, the lower leading face 430 is bounded by the lower leading face lower edge 438. The aperture forward face 348 begins on the side surface 600 at the inferior lower leading face insertion point 449. In some embodiments, the inferior lower leading face insertion point 449 begins as a point on the curviplanar or planar surface that is the rear side surface 630. The lower leading face lower edge 438 extends away from the side surface 600, e.g., away from the inferior lower leading face insertion point 449, and ends at the lateral edge of the wing 400. In some embodiments, the lower leading face lower edge 438 ends where the lower leading face lower edge 438 meets the lateral face of the wing 400, e.g., where the wing top surface leading edge 416 meets the wingtip lateral face leading edge 456.

In some embodiments, the wing 400 includes an outer lateral face, i.e., the outer lateral edge of the wing top surface 410 does not meet or is not coincident with the outer lateral edge of the wing bottom surface 500. In some embodiments wing 400 does not include an outer lateral face, i.e., the outer lateral edge of the wing top surface 410 meets or is coincident with the wing bottom surface 500. The embodiment of the curve-winged ripper point 100 shown in FIG. 3A includes an outer lateral face, e.g., wingtip lateral face 450. Turning to FIG. 6A, the wingtip lateral face 450 includes a wingtip lateral face upper edge 452, a wingtip lateral face lower edge 454, a wingtip lateral face leading edge 456 (meeting the wingtip lateral face upper edge 452 at the outer leading point 459) and a wingtip lateral face trailing edge 458 (meeting the wingtip lateral face lower edge 454 at the wing bottom surface trailing point 559). As discussed one or more of the leading edges of the wing 400, e.g., the wing top surface leading edge 416 and the upper leading face lower edge 428, may meet and/or terminate at the intersection of the wingtip lateral face leading edge 456 and the wingtip lateral face upper edge 452, i.e., the outer leading point 459. One or more of the leading edges of the wing 400, e.g., the lower leading face lower edge 438, may meet and/or terminate at the intersection of the wingtip lateral face leading edge 456 and wingtip lateral face lower edge 454. The wing top surface trailing edge 418 may terminate at the intersection of the wingtip lateral face trailing edge 458 and the wingtip lateral face upper edge 452. The trailing wing arch 522 may terminate at the intersection of the wingtip lateral face trailing edge 458 and the wingtip lateral face lower edge 454, e.g., the wing bottom surface trailing point 559. In some embodiments, the outer leading point 459 is the forwardmost point on the outer lateral aspect of the wing, e.g., on the wingtip lateral face 450. In some embodiments, the wing bottom surface trailing point 559 is the rearwardmost point on the outer lateral aspect of the wing, e.g., on the wingtip lateral face 450.

In some embodiments, the four edges of the wingtip lateral face 450, e.g., the wingtip lateral face upper edge 452, wingtip lateral face lower edge 454, wingtip lateral face leading edge 456, and wingtip lateral face trailing edge 458, form a trapezoid. In some embodiments, the wingtip lateral face upper edge 452 and the wingtip lateral face lower edge 454 are parallel. In other embodiments, the wingtip lateral face upper edge 452 and wingtip lateral face lower edge 454 are not parallel, e.g., the leading ends of the wingtip lateral face upper edge 452 and wingtip lateral face lower edge 454 are closer than the trailing ends, or the trailing ends of the wingtip lateral face upper edge 452 and wingtip lateral face lower edge 454 are closer than the leading ends. The structure of the wingtip lateral face 450 is defined by the lengths of the wingtip lateral face upper edge 452, wingtip lateral face lower edge 454 wingtip lateral face leading edge 456, and wingtip lateral face trailing edge 458 and, thus, the angles that these edges form. The wingtip lateral face upper edge 452 and the wingtip lateral face leading edge 456 connect at a leading wingtip angle 950. The wingtip lateral face leading edge 456 and the wingtip lateral face lower edge 454 connect at a trailing wingtip angle 952. The wingtip lateral face upper edge 452 and the wingtip lateral face trailing edge 458 connect at a leading rear-wingtip angle 954. The wingtip lateral face lower edge 454 and the wingtip lateral face trailing edge 458 connect at a trailing rear-wingtip angle 956.

In some embodiments, the leading wingtip angle 950 is greater than 90°. In such embodiments, the leading wingtip angle 950 may be: about 90°, 95°, 100°, 105°, 110°, 115°, 120°, 125°, 130°, 135°, or 140°; greater than about 90°, 95°, 100°, 105°, 110°, 115°, 120°, 125°, 130°, 135°, or 140°; between about 90-140°, 95°-130°, 100-120°, or 105-110°; or any other angle that advantageously interacts with the soil during use. In some embodiments, the leading wingtip angle 950 is approximately equal to 90°. In some embodiments, including that shown in FIG. 6A, the leading wingtip angle 950 is less than 90°. In such embodiments, the leading wingtip angle 950 may be: about 90°, 85°, 80°, 75°, 70°, 65°, 60°, 55°, or 50°; less than about 90°, 85°, 80°, 75°, 70°, 65°, 60°, 55°, or 50°; between about 20-90°, 25-85°, 30-80°, 35-75°, 40-70°, 45-65°, or 50-60°; or any other angle that advantageously interacts with the soil during use.

In some embodiments, including that shown in FIG. 6A, the trailing wingtip angle 952 is greater than 90°. In such embodiments, the trailing wingtip angle 952 may be: about 90°, 95°, 100°, 105°, 110°, 115°, 120°, 125°, 130°, 135°, or 140°; greater than about 90°, 95°, 100°, 105°, 110°, 115°, 120°, 125°, 130°, 135°, or 140°; between about 90-140°, 95°-130°, 100-120°, or 105-110°; or any other angle that advantageously interacts with the soil during use. In some embodiments, the trailing wingtip angle 952 is approximately equal to 90°. In some embodiments, the trailing wingtip angle 952 is less than 90°. In such embodiments, the trailing wingtip angle 952 may be: about 90°, 85°, 80°, 75°, 70°, 65°, 60°, 55°, or 50°; less than about 90°, 85°, 80°, 75°, 70°, 65°, 60°, 55°, or 50°; between about 20-90°, 25-85°, 30-80°, 35-75°, 40-70°, 45-65°, or 50-60°; or any other angle that advantageously interacts with the soil during use.

In some embodiments, the leading rear-wingtip angle 954 is greater than 90°. In such embodiments, the leading rear-wingtip angle 954 may be: about 90°, 95°, 100°, 105°, 110°, 115°, 120°, 125°, 130°, 135°, or 140°; greater than about 90°, 95°, 100°, 105°, 110°, 115°, 120°, 125°, 130°, 135°, or 140°; between about 90-140°, 95°-130°, 100-120°, or 105-110°; or any other angle that advantageously interacts with the soil during use. In some embodiments, the leading rear-wingtip angle 954 is approximately equal to 90°. In some embodiments, the leading rear-wingtip angle 954 is less than 90°. In such embodiments, the leading rear-wingtip angle 954 may be: about 90°, 85°, 80°, 75°, 70°, 65°, 60°, 55°, or 50°; less than about 90°, 85°, 80°, 75°, 70°, 65°, 60°, 55°, or 50°; between about 20-90°, 25-85°, 30-80°, 35-75°, 40-70°, 45-65°, or 50-60°; or any other angle that advantageously interacts with the soil during use.

In some embodiments, the trailing rear-wingtip angle 956 is greater than 90°. In such embodiments, the trailing rear-wingtip angle 956 may be: about 90°, 95°, 100°, 105°, 110°, 115°, 120°, 125°, 130°, 135°, or 140°; greater than about 90°, 95°, 100°, 105°, 110°, 115°, 120°, 125°, 130°, 135°, or 140°; between about 90-140°, 95°-130°, 100-120°, or 105-110°; or any other angle that advantageously interacts with the soil during use. In some embodiments, the trailing rear-wingtip angle 956 is approximately equal to 90°. In some embodiments, the trailing rear-wingtip angle 956 is less than 90°. In such embodiments, the trailing rear-wingtip angle 956 may be: about 90°, 85°, 80°, 75°, 70°, 65°, 60°, 55°, or 50°; less than about 90°, 85°, 80°, 75°, 70°, 65°, 60°, 55°, or 50°; between about 20-90°, 25-85°, 30-80°, 35-75°, 40-70°, 45-65°, or 50-60°; or any other angle that advantageously interacts with the soil during use.

As shown, the leading wing root insertion point 442 is positioned in front of the inferior upper leading face insertion point 447, which is positioned in front of the inferior lower leading face insertion point 449. In the same way, the inferior lower leading face insertion point 449 is positioned in front of the outer leading point 459 of the wing 400. While the angle of attack 940 may affect the vertical positioning of the various structures of the curve-winged ripper point 100, given the angle of attack 940 shown in FIG. 6A, the leading wing root insertion point 442 is positioned above the upper leading face root 446, which is positioned above the inferior lower leading face insertion point 449. In the same way, the inferior lower leading face insertion point 449 is positioned above the outer leading point 459 of the wing 400.

The wing 400 on each side of the body of the curve-winged ripper point 100 may generally slope or angle downward, e.g., at least a portion the wingtip lateral face upper edge 452 may be lower than at least a portion of the wing root 440 relative to the vertical. In some embodiments, all of the wingtip lateral face 450 is at or lower than the level of the trailing wing root insertion point 444 with respect to the vertical. In such embodiments, the wing 400 may angle or slope downward with respect to the horizontal in at least one direction or aspect. In some embodiments, only a portion, e.g., less than all, of the wingtip lateral face 450 is at or lower than the level of the trailing wing root insertion point 444 with respect to the vertical. In such embodiments, the wing 400 may be substantially level with the horizontal in at least one direction or aspect. In other embodiments, all of the wingtip lateral face 450 is at or above the level of the trailing wing root insertion point 444 with respect to the vertical. In such embodiments, the wing 400 may angle or sloe upward with respect to the horizontal in at least one direction or aspect.

As discussed, the 440 may be coextensive with the third upper surface face lateral edge 134. Thus, the wing root 440 may be positioned at an angle with respect to horizontal that is substantially equal to the angle of attack 940. In some embodiments, the wing top surface 410 of the wing 400 extends outward and downward from the wing root 440 such that a line connecting the wing top surface leading edge 416 to the wing top surface trailing edge 418 and parallel to the line of bilateral symmetry 902 is substantially equal to or greater than the angle of attack 940. In some embodiments, the wingtip lateral face upper edge 452 is positioned at an angle with respect to horizontal that is substantially equal to the angle of attack 940. In some embodiments, the wingtip lateral face upper edge 452 is positioned at an angle with respect to horizontal that is greater than the angle of attack. In such embodiments, the wingtip lateral face upper edge 452 is positioned at an angle with respect to horizontal that is greater than the angle of attack by about 2°, 4°, 6°, 8°, 10°, 12°, 14°, 16°, 18°, or 20°. In some embodiments, the wingtip lateral face upper edge 452 is positioned at an angle with respect to horizontal that is less than the angle of attack. In such embodiments, the wingtip lateral face upper edge 452 is positioned at an angle with respect to horizontal that is less than the angle of attack by about 2°, 4°, 6°, 8°, 10°, 12°, 14°, 16°, 18°, or 20°. In some embodiments, the wingtip lateral face lower edge 454 is positioned at an angle with respect to horizontal that is substantially equal to the angle of attack 940. In some embodiments, the wingtip lateral face lower edge 454 is positioned at an angle with respect to horizontal that is greater than the angle of attack. In such embodiments, the wingtip lateral face lower edge 454 is positioned at an angle with respect to horizontal that is greater than the angle of attack by about 2°, 4°, 6°, 8°, 10°, 12°, 14°, 16°, 18°, or 20°. In some embodiments, the wingtip lateral face lower edge 454 is positioned at an angle with respect to horizontal that is less than the angle of attack. In such embodiments, the wingtip lateral face lower edge 454 is positioned at an angle with respect to horizontal that is less than the angle of attack by about 2°, 4°, 6°, 8°, 10°, 12°, 14°, 16°, 18°, or 20°.

In some embodiments, including that shown in FIG. 2, the wing top surface leading edge 416 is substantially curvilinear. In some embodiments, the wing top surface leading edge 416 is substantially linear. In other embodiments, the wing top surface leading edge 416 includes both curvilinear and linear portions. In some embodiments, including that shown in FIG. 2, the upper leading face lower edge 428 is substantially curvilinear. In some embodiments, the upper leading face lower edge 428 is substantially linear. In other embodiments, the upper leading face lower edge 428 includes both curvilinear and linear portions. In some embodiments, including that shown in FIG. 2, the lower leading face lower edge 438 is substantially curvilinear. In some embodiments, the lower leading face lower edge 438 is substantially linear. In other embodiments, the lower leading face lower edge 438 includes both curvilinear and linear portions. In some embodiments, including that shown in FIG. 2, the wing top surface trailing edge 418 is substantially curvilinear. In some embodiments, the wing top surface trailing edge 418 is substantially linear. In other embodiments, the wing top surface trailing edge 418 includes both curvilinear and linear portions. In some embodiments, including that shown in FIG. 2, the trailing wing arch 522 is substantially curvilinear. In some embodiments, the trailing wing arch 522 is substantially linear. In other embodiments, the trailing wing arch 522 includes both curvilinear and linear portions. In some embodiments, including that shown in FIG. 2, the wing bottom surface outer trailing edge 520 is substantially linear. In some embodiments, the wing bottom surface outer trailing edge 520 is substantially curvilinear. In other embodiments, the wing bottom surface outer trailing edge 520 includes both curvilinear and linear portions.

In some embodiments, at least one front surface of the wing 400, including at least one or more of the upper leading face 420 and the lower leading face 430, are wholly or substantially curviplanar. In other embodiments, at least one front surface of the wing 400, including at least one or more of the upper leading face 420 and the lower leading face 430, are wholly or substantially planar. In yet other embodiments, at least one front surface of the wing 400, including at least one or more of the upper leading face 420 and the lower leading face 430, include both curviplanar and planar portions. In some embodiments, the rear face of the wing, including at least one or more of at least a portion of the rear upper shoulder 210, rear middle shoulder 220, and rear wing face 230, is wholly or substantially curviplanar. In other embodiments, the rear face of the wing, including at least one or more of at least a portion of the rear upper shoulder 210, rear middle shoulder 220, and rear wing face 230, is wholly or substantially planar. In yet other embodiments, the rear face of the wing, including at least one or more of at least a portion of the rear upper shoulder 210, rear middle shoulder 220, and rear wing face 230, includes both curviplanar and planar portions. In some embodiments, the wing top surface 410 of the wing 400, including at least the outer wing top surface 414 and the inner wing top surface 412, is wholly or substantially curviplanar. In other embodiments, the wing top surface 410 of the wing 400, including at least the outer wing top surface 414 and the inner wing top surface 412, is wholly or substantially planar. In yet other embodiments, the wing top surface 410 of the wing 400, including at least the outer wing top surface 414 and the inner wing top surface 412, includes both curviplanar and planar portions. In some embodiments, the wing bottom surface 500 of the wing 400, including at least the outer wing bottom surface 514 and the inner wing bottom surface 512, is wholly or substantially curviplanar. In other embodiments, the wing bottom surface 500 or the wing 400, including at least the outer wing bottom surface 514 and the inner wing bottom surface 512, is wholly or substantially planar. In yet other embodiments, the wing bottom surface 500 of the wing 400, including at least the outer wing bottom surface 514 and the inner wing bottom surface 512, includes both curviplanar and planar portions.

Wing thickness as used herein may be defined in any of a number of ways. In some embodiments, the wing thickness is defined as the thickness of the wing 400 along any vertical line intersecting the wing 400 and parallel to the plane containing the wingtip lateral face 450. In some embodiments, the wing thickness is defined as the thickness of the wing 400 along any vertical line intersecting the wing 400 and parallel to the rear side surface 630. In other embodiments, the wing thickness is defined as the thickness of the wing 400 along any vertical line intersecting the wing 400 and parallel to the middle side surface 620. In yet other embodiments, the wing thickness is defined as the thickness of the wing 400 along any vertical line intersecting the wing 400 and parallel to the forward side surface 610. In some embodiments, the wing thickness is defined as the thickness of the wing 400 along any line intersecting the wing 400 and perpendicular to a plane containing the third upper surface face 130. In some embodiments, the wing thickness is defined as the thickness of the wing 400 along any line intersecting the wing 400 and perpendicular to a plane containing the second upper surface face 120. In some embodiments, the wing thickness is defined as the thickness of the wing 400 along any line intersecting the wing 400 and perpendicular to a plane containing or tangential to the surface of the wing 400 where intersected by the line. In some embodiments, the wing thickness is defined as the thickness of the wing 400 along any line intersecting the wing 400 and parallel to the plane containing the shank socket lateral edges 310, the shank socket lower edge 320, and the shank socket upper edge 330.

In some embodiments, the wing root 440 at the leading edge of the wing 400 has a thickness that is greater than the thickness of the wing 400 at its outer lateral edge. In some embodiments, the wing thickness is constantly decreasing from the wing root 440 to the wingtip lateral face 450. The constant decrease in wing thickness may be linear or the constant decrease in wing thickness may not be linear. In some embodiments, the wing thickness decreases across only a portion of the length of the wing from the wing root 440 to the wingtip lateral face 450. For example, the wing thickness may decrease across the entire inner wing containing the entire inner wing top surface 412 and/or the entire inner wing bottom surface 512. The wing thickness may decrease across the entire outer wing containing the entire outer wing top surface 414 and/or the entire outer wing bottom surface 514. In other examples, the wing thickness may decrease across only a portion of the inner wing containing the inner wing top surface 412 and/or the inner wing bottom surface 512. The wing thickness may decrease across only a portion of the outer wing containing the outer wing top surface 414 and/or the outer wing bottom surface 514. In some embodiments, no portion of the outer wing, containing the outer wing top surface 414 and/or the outer wing bottom surface 514, is thicker than any portion of the inner wing, containing the inner wing top surface 412 and/or the inner wing bottom surface 512.

As illustrated in FIG. 2, the curve-winged ripper point 100 may include a wear detector 800. The wear detector 800 may include a raised material extending away from the upper surface 104, e.g., in a direction substantially perpendicular to the third upper surface face 130 of the upper surface 104. The wear detector 800 is configured to wear away during use. For example, the wear detector 800 is configured to be worn away by the passage of soil over the wear detector 800, which occurs during use of the curve-winged ripper point 100. As the curve-winged ripper point 100 is used, e.g., drug or forced through the soil, the wear detector 800 is worn away. The wear detector 800 may be worn away in a substantially linear fashion. For example, the wear detector 800 may decrease by a set measurement over a set number of hours of use. The wear detector 800 may be designed or configured to wear away, e.g., completely or substantially completely at the end of the life span of the curve-winged ripper point 100. That is to say, the curve-winged ripper point 100 has an ideal or designed useful lifetime (e.g., a set number of in-use hours), after which performance, e.g., performance of the ripper point, may degrade or failure rates may increase. The wear detector 800 may be configured to substantially wear away by approximately the end of the ideal or designed useful lifetime of the curve-winged ripper point 100 (e.g., the same set number of in-use hours). Thus, the presence of all or a portion of the wear detector 800 may indicate to a user that the curve-winged ripper point 100 is still appropriate for use. And, in the same way, the absence of all or substantially all of the wear detector 800 may indicate to the user that the curve-winged ripper point 100 should ideally be replaced. Wear detectors such as those described herein may be used on various ground engaging components, such as, but not limited to ripper points, sweeps, shanks, etc.

The wear detector 800 may extend away from the upper surface 104. In some embodiments, the wear detector 800 is located on the uppermost distinct section of the upper surface 104, i.e., in FIG. 2, the third upper surface face 130. In other embodiments, the wear detector 800 may be located on the first upper surface face 110, the second upper surface face 120, or the third upper surface face 130. In still other embodiments, the wear detector 800 may be located on the side surface 600, e.g., the forward side surface 610, the middle side surface 620 or the rear side surface 630. In yet other embodiments, the wear detector 800 may be located on one or both of the wings 400.

There may be a relationship between the angle of attack of the surface on which the wear detector 800 is located and the rate at which the wear detector 800 wears away, e.g., and at what point the wear detector 800 indicates that replacement of the curve-winged ripper point 100 may be desirable. For example, and as shown in FIG. 6A, the third upper surface face 130 has an angle of attack 940, which is less than the angle of attack of the second upper surface face 120 (which is equivalent to the angle of attack 940 plus (180 minus the second upper surface joint angle 932)), which is still less than the angle of attack of the first upper surface face 110 (which is equivalent to the angle of attack of the second upper surface face 120 plus (180 minus the first upper surface joint angle 922)). The skilled person will understand that the relationship between material wear and the angle of attack of the surface on which the wear detector 800 is located. The steeper the angle of attack, the fast the material of the wear detector 800 will wear away as there are higher forces pushing down on and wearing away the wear detector 800. In some embodiments, the height of the wear detector 800 necessary to indicate wear is directly or linearly proportional to the increase in attack angle. For example, the height of the wear detector 800 may be increased by 10% if the attack angle is increased by 10%, and so on.

The wear detector 800 is configured in such a way that soil can wear away all or substantially all of the wear detector 800 substantially by the end of the ideal or designed useful lifetime of the curve-winged ripper point 100. In some embodiments, wear detector 800 wearing away is defined in terms of percentage of material remaining (or mass), e.g., regardless of how far away from the upper surface 104 the wear detector 800 still extends. In other embodiments, the wear detector 800 wearing away is defined in terms of reduction of height, e.g., how far away from the upper surface 104 the wear detector 800 extends, e.g., regardless of how much material is still present.

In some embodiments, at the ideal or designed useful lifetime of the curve-winged ripper point 100, the wear detector 800 is configured to have worn away (e.g., in terms of either height or mass) by about 100%, 98%, 96%, 94%, 92, 90%, 88%, 86%, 84%, 82%, or 80%, or any other amount that advantageously informs a user regarding the lifespan of the curve-winged ripper point 100. In some embodiments, at the ideal or designed useful lifetime of the curve-winged ripper point 100, the wear detector 800 is configured to have worn away (e.g., in terms of either height or mass) by more than about 98%, 96%, 94%, 92, 90%, 88%, 86%, 84%, 82%, or 80%, or any other amount that advantageously informs a user regarding the lifespan of the curve-winged ripper point 100.

One of ordinary skill in the art will understand that the wear detector 800 may be configured differently depending on various features and/or structures of the curve-winged ripper point 100. For example, a harder material forming the wear detector 800 (and in some embodiments, the curve-winged ripper point 100) may require less of at least one of height of the wear detector 800 and mass of the wear detector 800. That is because harder materials wear away slower due to the eroding effects of soil flow (caused by use). In the same way, a softer material forming the wear detector 800 (and in some embodiments, the curve-winged ripper point 100) may require more of at least one of height of the wear detector 800 and mass of the wear detector 800. That is because softer materials wear away faster due to the eroding effects of soil flow. In another example, a more aggressive angle of attack 940 may require more of at least one of height of the wear detector 800 and mass of the wear detector 800. That is because increased angles of attack 940 cause increased forces on the upper surface 104 of the curve-winged ripper point 100 and thus increased forces on the wear detector 800 which increase eroding effects of the soil flow on the wear detector 800. In the same way, a less aggressive angle of attack 940 may require less of at least one of height of the wear detector 800 and mass of the wear detector 800. That is because decreased angles of attack 940 generate fewer forces on the upper surface 104 of the curve-winged ripper point 100 and thus decreased forces on the wear detector 800 which ease the eroding effects of the soil flow on the wear detector 800.

As shown in FIG. 6A, the wear detector 800 may extend away from a surface of the curve-winged ripper point 100, e.g., the upper surface 104 or the third upper surface face 130 of the upper surface 104, substantially perpendicular to the plane on which it is located. In some embodiments, the wear detector 800 extends away from a surface of the curve-winged ripper point 100 in a direction substantially perpendicular to the angle of attack 940 (e.g., the angle of attack 940 plus ninety degrees). In other embodiments, the wear detector 800 extends away from a surface of the curve-winged ripper point 100 in a backswept direction, e.g., a direction less than perpendicular to the angle of attack 940 (e.g., the angle of attack 940 plus less than ninety degrees).

The wear detector 800 may be made out of the same material as the curve-winged ripper point 100. In some embodiments, the wear detector 800 is made out of a different material from the curve-winged ripper point 100, e.g., a harder material or a softer material. In some embodiments, the lifespan of the wear detector 800 may be tailored to the lifespan of the curve-winged ripper point 100 using one or more of mass of the wear detector 800, e.g., any one or more of height, front to back width, side to side width, etc., and hardness of the material out of which the wear detector 800 is made. For example, a very hard wear detector 800 may be smaller in size than a wear detector 800 made out of a very soft material, which would need to include much more mass as it would wear away faster. In some embodiments, the wear detector 800 is made out of a material softer than the curve-winged ripper point 100. In such embodiments, the wear detector 800 may wear away substantially fully at or around the time that the lifespan of the curve-winged ripper point 100 is finished. The material of the wear detector 800 being softer than the material of the curve-winged ripper point 100 may advantageously allow the wear detector 800 to wear away smoothly and fully upon the lifespan of the curve-winged ripper point 100 being finished—in these cases, the user of the curve-winged ripper point 100, e.g., a farmer or other machine user, may easily see or feel that the wear detector 800 is no longer present.

In some embodiments, the wear detector 800 is configured to have a percentage of its mass removed after the useable life of the curve-winged ripper point 100 has been reached. For example, the wear detector 800 may be configured to have a percentage of its mass removed of at least 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. In other examples, the wear detector 800 may be configured to have a percentage of its mass removed of between 75-100%, 77.5-99.5%, 80-99%, 82.5-98.5%, 85-98%, 87.5-97.5%, 90-97%, 92.5-96.5%, or 95-96%, or any other mass percentage that advantageously signals to a user of the curve-winged ripper point 100 that the useable life of the curve-winged ripper point 100 has been reached. As explained herein, the percentage of mass removal may be dependent on or related to the angle of attack of the surface on which the wear detector 800 is located and/or the material out of which the wear detector 800 is made.

In some embodiments, the wear detector 800 is configured to have a percentage of its height, e.g., the distance perpendicular to the surface from which the wear detector 800 extends, reduced after the usable life of the curve-winged ripper point 100 has been reached. For example, the wear detector 800 may be configured to have a percentage of its height removed of at least 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. In other examples, the wear detector 800 may be configured to have a percentage of its height removed of between 75-100%, 77.5-99.5%, 80-99%, 82.5-98.5%, 85-98%, 87.5-97.5%, 90-97%, 92.5-96.5%, or 95-96%, or any other height percentage that advantageously signals to a user of the curve-winged ripper point 100 that the useable life of the curve-winged ripper point 100 has been reached. As explained herein, the percentage of height removal is dependent on or related to the angle of attack of the surface on which the wear detector 800 is located and/or the material out of which the wear detector 800 is made.

In some embodiments, the wear detector 800 has a height, e.g., a height or distance perpendicular to the surface from which the wear detector 800 extends of about 4 mm. In some embodiments, the wear detector 800 has a height of less than or about 12 mm, 11 mm, 10 mm, 9 mm, 8 mm, 7 mm, 6 mm, 5 mm, 4 mm, 3 mm, 2 mm, 1 mm, or any other height that is advantageously reduced as disclosed herein to effectively signal to a user of the curve-winged ripper point 100 that the useable life of the curve-winged ripper point 100 has been reached. As disclosed herein, the height of the wear detector 800 may be greater when the wear detector 800 is located on a surface having an increased angle of attack.

In some embodiments, the curve-winged ripper point 100 may include more than one wear detector 800. In some embodiments, the curve-winged ripper point 100 includes 1, 2, 3, 4, 5, or 6 wear detectors 800. In one example, the curve-winged ripper point 100 includes a first wear detector 800 on the first upper surface face 110, a second wear detector 800 on the second upper surface face 120, and a third wear detector 800 on the third upper surface face 130. As explained herein, the first wear detector 800 on the first upper surface face 110 may have a greater height (and/or mass) than the second wear detector 800 on the second upper surface face 120, which may have a greater height (and/or mass) than the third wear detector 800 on the third upper surface face 130—in this way, the first wear detector 800 on the first upper surface face 110 and the second wear detector 800 on the second upper surface face 120 and the third wear detector 800 on the third upper surface face 130 may wear away at approximately the same rate (though they are not visually and/or dimensionally identical or similar). As explained herein, the first wear detector 800 on the first upper surface face 110 may have a greater harness than the second wear detector 800 on the second upper surface face 120, which may have a greater harness than the third wear detector 800 on the third upper surface face 130—in this way, each of the first wear detector 800 on the first upper surface face 110 and the second wear detector 800 on the second upper surface face 120 and the third wear detector 800 on the third upper surface face 130 may be visually and/or dimensionally similar or identical and still wear away at approximately the same rate. Having more than one wear detector 800, e.g., such as just mentioned, may advantageously allow the user to determine whether the curve-winged ripper point 100 is positioned at the correct angle with respect to the soil during use. For example, if the first wear detector 800 on the first upper surface face 110 and/or the second wear detector 800 on the second upper surface face 120 wear faster than the second wear detector 800 on the second upper surface face 120 and/or the third wear detector 800 on the third upper surface face 130, the 100 may be at too great an angle of attack. In the same way if the first wear detector 800 on the first upper surface face 110 and/or the second wear detector 800 on the second upper surface face 120 wear slower than the second wear detector 800 on the second upper surface face 120 and/or the third wear detector 800 on the third upper surface face 130, the 100 may be at too low an angle of attack.

In some embodiments, the wear detector 800, e.g., each wear detector 800, is positioned along the middle of the curve-winged ripper point 100, i.e., midway between the lateral sides of the surface from which it/the extend(s). In some embodiments, the curve-winged ripper point 100 may have two or more wear detector 800 on one surface. One wear detector 800 may be offset by a distance towards the leftmost lateral side of the surface. One wear detector 800 may be offset by a distance towards the rightmost lateral side of the surface. Such positioning and multiple wear detectors 800 (on one or more of the different surfaces of the curve-winged ripper point 100), may advantageously indicate to a user of the curve-winged ripper point 100 whether the curve-winged ripper point 100 is laterally balanced.

In some embodiments, the wear detector 800 extends from the third upper surface face 130 and is located at or close to the midline of the third upper surface face 130. The wear detector 800 may be located closer to the second upper surface joint 132 than the trailing wing root insertion point 444. The wear detector 800 may be located closer to the trailing wing root insertion point 444 than the second upper surface joint 132. Or, the wear detector 800 may be located equidistant or approximately equidistant between the second upper surface joint 132 and the trailing wing root insertion point 444. In some embodiments, the wear detector 800 is positioned rearward from the second upper surface joint 132 by a percentage of the distance between the second upper surface joint 132 and the trailing wing root insertion point 444. In some embodiments, the wear detector 800 is positioned by a percentage of the distance between the second upper surface joint 132 and the trailing wing root insertion point 444 of about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the second upper surface joint 132 and the trailing wing root insertion point 444 of greater than about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the second upper surface joint 132 and the trailing wing root insertion point 444 of less than about 5%, 10%, 15%, 20%, 25%, 30%, 35%, 40%, 45%, 50%, 55%, 60%, 65%, 70%, 75%, 80%, 85%, 90%, or 95%. In yet other embodiments, the wear detector 800 is positioned by a percentage of the distance between the second upper surface joint 132 and the trailing wing root insertion point 444 of between about 40-90%, 45-85%, 50-80%, 55-75%, or 60-70%.

In some embodiments, the wear detector 800 extends from the second upper surface face 120 and is located at or close to the midline of the second upper surface face 120. The wear detector 800 may be located closer to the first upper surface joint 122 than the second upper surface joint 132. The wear detector 800 may be located closer to the second upper surface joint 132 than the first upper surface joint 122. Or, the wear detector 800 may be located equidistant or approximately equidistant between the first upper surface joint 122 and the second upper surface joint 132. In some embodiments, the wear detector 800 is positioned rearward from the first upper surface joint 122 by a percentage of the distance between the first upper surface joint 122 and the second upper surface joint 132. In some embodiments, the wear detector 800 is positioned by a percentage of the distance between the first upper surface joint 122 and the second upper surface joint 132 of about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the first upper surface joint 122 and the second upper surface joint 132 of greater than about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the first upper surface joint 122 and the second upper surface joint 132 of less than about 5%, 10%, 15%, 20%, 25%, 30%, 35%, 40%, 45%, 50%, 55%, 60%, 65%, 70%, 75%, 80%, 85%, 90%, or 95%. In yet other embodiments, the wear detector 800 is positioned by a percentage of the distance between the first upper surface joint 122 and the second upper surface joint 132 of between about 40-90%, 45-85%, 50-80%, 55-75%, or 60-70%.

In some embodiments, the wear detector 800 extends from the first upper surface face 110 and is located at or close to the midline of the first upper surface face 110. The wear detector 800 may be located closer to the nose edge 112 than the first upper surface joint 122. The wear detector 800 may be located closer to the first upper surface joint 122 than the nose edge 112. Or, the wear detector 800 may be located equidistant or approximately equidistant between the nose edge 112 and the first upper surface joint 122. In some embodiments, the wear detector 800 is positioned rearward from the nose edge 112 by a percentage of the distance between the nose edge 112 and the first upper surface joint 122. In some embodiments, the wear detector 800 is positioned by a percentage of the distance between the nose edge 112 and the first upper surface joint 122 of about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the nose edge 112 and the first upper surface joint 122 of greater than about 5%, 10%, 15%, 20%, 25%, 30%, 35%, 40%, 45%, 50%, 55%, 60%, 65%, 70%, 75%, 80%, 85%, 90%, or 95%. In some embodiments, the wear detector 800 is positioned by a percentage of the distance between the nose edge 112 and the first upper surface joint 122 of less than about 5%, 10%, 15%, 20%, 25%, 30%, 35%, 40%, 45%, 50%, 55%, 60%, 65%, 70%, 75%, 80%, 85%, 90%, or 95%. In yet other embodiments, the wear detector 800 is positioned by a percentage of the distance between the nose edge 112 and the first upper surface joint 122 of between about 40-90%, 45-85%, 50-80%, 55-75%, or 60-70%.

The foregoing description and examples have been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Although systems and methods for tillage ripper points have been disclosed in the context of certain embodiments and examples, this disclosure extends beyond the specifically disclosed embodiments to other alternative embodiments and/or uses of the embodiments and certain modifications and equivalents thereof. Various features and aspects of the disclosed embodiments can be combined with or substituted for one another in order to form varying modes of systems and methods for tillage ripper points. The scope of this disclosure should not be limited by the particular disclosed embodiments described herein.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication. For example, actions such as “positioning an electrode” include “instructing positioning of an electrode.”The ranges disclosed herein also encompass any and all overlap, subranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 1 V” includes “1 V.” Phrases preceded by a term such as “substantially” include the recited phrase and should be interpreted based on the circumstances (e.g., as much as reasonably possible under the circumstances). For example, “substantially perpendicular” includes “perpendicular.” Unless stated otherwise, all measurements are at standard conditions including temperature and pressure.

In summary, various embodiments and examples of systems and methods for tillage ripper points have been disclosed. Although the systems and methods for tillage ripper points have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

What is claimed is:

1. A tillage ripper point, the ripper point comprising:
a body comprising a first upper surface having first and second first upper surface lateral edges, a second upper surface having first and second second upper surface later edges, a third upper surface having first and second third upper surface lateral edges, first and second lateral sides, and a nose at least partially defining a leading edge of the first upper surface;
a first wing extending from the first lateral side of the body and a second wing extending from the second lateral side of the body, wherein each of the first wing and the second wing comprises a top surface extending from the body of the ripper point, a bottom surface extending from the body of the ripper point, and a wing thickness; and
at least one ripper point wear detector extending a distance from a surface of the ripper point, wherein the ripper point wear detector is configured to be substantially worn away at approximately the same time that the tillage ripper point reaches an end of a lifespan of the tillage ripper point.

2. The tillage ripper point of claim 1, wherein the at least one ripper point wear detector comprises at least one of a first ripper point wear detector comprising a first material having a first material hardness and extending a first distance from the first upper surface located between the first and second first upper surface lateral edges, a second ripper point wear detector comprising a second material having a second material hardness and extending a second distance from the second upper surface located between the first and second second upper surface lateral edges, and a third ripper point wear detector comprising a third material having a third material hardness and extending a third distance from the third upper surface located between the first and second third upper surface lateral edges.

3. The tillage ripper point of claim 2, wherein at least one of the third material of the third ripper point wear detector and the second material of the second ripper point wear detector is different from the first material of the first ripper point wear detector.

4. The tillage ripper point of claim 3, wherein at least one of the third material hardness of the third ripper point wear detector and the second material hardness of the second ripper point wear detector is different from the first material hardness of the first ripper point wear detector.

5. The tillage ripper point of claim 4, wherein at least one of the third material hardness of the third ripper point wear detector and the second material hardness of the second ripper point wear detector is greater than the first material hardness of the first ripper point wear detector.

6. The tillage ripper point of claim 2, wherein at least one of the third distance of the third ripper point wear detector and the second distance of the second ripper point wear detector is different from the first distance of the first ripper point wear detector.

7. The tillage ripper point of claim 6, wherein at least one of the third distance of the third ripper point wear detector and the second distance of the second ripper point wear detector is greater than the first distance of the first ripper point wear detector.

8. The tillage ripper point of claim 2, wherein the at least one ripper point wear detector comprises at least two of the first ripper point wear detector, and second ripper point wear detector, and the third ripper point wear detector.

9. A tillage ripper point, the ripper point comprising:
a body comprising at least one upper surface having first and second lateral edges, first and second lateral sides, and a nose;
a first wing extending from the first lateral side of the body and a second wing extending from the second lateral side of the body, wherein each of the first wing and the second wing comprises a top surface extending from the body of the ripper point, a bottom surface extending from the body of the ripper point, and a wing thickness; and
a ripper point wear detector extending from a first upper surface of the at least one upper surface, wherein the ripper point wear detector is configured to be worn away during use of the tillage ripper point and by reaching a worn state indicate that the tillage ripper point has reached an end of a lifespan of the tillage ripper point.

10. The tillage ripper point of claim 9, wherein the ripper point wear detector extends from the first upper surface of the at least one upper surface at a location at least partially intersecting a midline of the first upper surface between the first and second lateral edges of the first upper surface.

11. The tillage ripper point of claim 9, wherein the ripper point wear detector comprises a mass and the worn state of the ripper point wear detector corresponds to a mass reduction of the ripper point wear detector of greater than 90%.

12. The tillage ripper point of claim 11, wherein the worn state of the ripper point wear detector corresponds to a mass reduction of the ripper point wear detector of greater than 96%.

13. The tillage ripper point of claim 9, wherein the ripper point wear detector extends from the first upper surface by a dimension and the worn state of the ripper point wear detector corresponds to a reduction of the dimension of the ripper point wear detector of greater than 90%.

14. The tillage ripper point of claim 13, wherein the worn state of the ripper point wear detector corresponds to a reduction of the dimension of the ripper point wear detector of greater than 96%.

15. The tillage ripper point of claim 9, wherein the ripper point wear detector comprises a ripper point wear detector material that is different than a material of the body of the tillage ripper point.

16. The tillage ripper point of claim 15, wherein the ripper point wear detector material is softer than the material of the body of the tillage ripper point.

17. A wear detector for a soil engaging component of an agricultural implement, the wear detector comprising:
a wear detector body having a mass and extending a distance from a soil engaging surface of the soil engaging component of the agricultural implement, wherein the wear detector is configured to be worn away during use of the soil engaging component of the agricultural implement and by reaching a worn state indicate that the soil engaging component of the agricultural implement has reached an end of a lifespan of the soil engaging component of the agricultural implement.

18. The wear detector of claim 17, wherein the worn state of the wear detector corresponds to a reduction in the mass of the wear detector by at least 90%.

19. The wear detector of claim 17, wherein the worn state of the wear detector corresponds to a reduction in the distance the wear detector extends from the soil engaging surface of the soil engaging component by at least 90%.

20. The wear detector of claim 17, wherein a material of the wear detector body is different from a material of the soil engaging component.
